(19) United States
(12) Patent Application Publication
(10) Pub. No.: US 2023/0284267 A1
(43) Pub. Date: Sep. 7, 2023

(54) REDUCED SENSING FOR REDUCED CAPABILITY UES

(71) Applicant: Fraunhofer-Gesellschaft zur Förderung der angewandten Forschung e.V., München (DE)

(72) Inventors: Thomas FEHRENBACH, Berlin (DE); Sarun SELVANESAN, Berlin (DE); Baris GÖKTEPE, Berlin (DE); Thomas WIRTH, Berlin (DE); Thomas SCHIERL, Berlin (DE); Cornelius HELLGE, Berlin (DE)

(21) Appl. No.: 18/156,705

(22) Filed: Jan. 19, 2023

Related U.S. Application Data
(63) Continuation of application No. PCT/EP2021/069873, filed on Jul. 15, 2021.

(30) Foreign Application Priority Data
Jul. 23, 2020 (EP) 20187541.6

(51) Int. Cl. H04W 74/08

(52) U.S. Cl. CPC H04W 74/0808

(57) ABSTRACT

A user device, UE, for a wireless communication network is described. A set of resources is provided for a communication in the wireless communication network. The UE is to operate, e.g., carry out sensing, only on one or more subsets of frequency resources of the set of resources, wherein a number of frequency resources of the subset of frequency resources is less than a total number of frequency resources of the set of resources.

### CROSS-REFERENCE TO RELATED APPLICATIONS

This application is a continuation of copending International Application No. PCT/EP2021/069873, filed Jul. 15, 2021, which is incorporated herein by reference in its entirety, and additionally claims priority from European Application No. EP 20187541.6, filed Jul. 23, 2020, which is also incorporated herein by reference in its entirety.

The present invention relates to the field of wireless communication systems or networks, more specifically, to the field of device-to-device communications, like vehicle-to-everything, V2X, communications, within such a wireless communication system or network. Embodiments relate to the operation of user devices, UEs, carrying out reduced sensing across frequency, like UEs operating in Mode 1 so as to carry out sensing, e.g. to generate a sensing report, or in Mode 2 so as to autonomously carry out resource selection and allocation by sensing.

### BACKGROUND OF THE INVENTION

FIGS. 1 is a schematic representation of an example of a terrestrial wireless network 100 including, as is shown in FIG. 1(a), the core network 102 and one or more radio access networks RAN₁, RAN₂, ...RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/ LTE-A Pro, or just a BS in other mobile communication standards. A user may be a stationary device or a mobile device. The wireless communication system may also be accessed by mobile or stationary loT devices which connect to a base station or to a user. The mobile devices or the loT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two loT devices 110₁ and 110₂ in cell 106₄, which may be stationary or mobile devices. The loT device 110₁ accesses the wireless communication system via the base station gNB₄ to receive and transmit data as schematically represented by arrow 112₁. The loT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi or 4G or 5G mobile communication system. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. Note, the sidelink interface may a support 2-stage SCI. This refers to a first control region containing some parts of the SCI, and optionally, a second control region, which contains a second part of control information. For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also consist of a smaller number of OFDM symbols, e.g. when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including space-borne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. RSUs may have functionalities of BS or of UEs, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 2(a) is a schematic representation of an in-coverage scenario in which two UEs directly communicating with each other are both connected to a base station. The base station gNB has a coverage area that is schematically represented by the circle 150 which, basically, corresponds to the cell schematically represented in FIG. 1. The UEs directly communicating with each other include a first vehicle 152 and a second vehicle 154 both in the coverage area 150 of the base station gNB. Both vehicles 152, 154 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a Mode 1 configuration in NR V2X or as a Mode 3 configuration in LTE V2X.

FIG. 2(b) is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 156, 158 and 160 are shown directly communicating with each other over a sidelink, e.g., using the PC5 interface. The scheduling and/or interference management of the V2V traffic is based on algorithms implemented between the vehicles. This configuration is also referred to as a Mode 2 configuration in NR V2X or as a Mode 4 configuration in LTE V2X. As mentioned above, the scenario in FIG. 2(b) which is the out-of-coverage scenario does not necessarily mean that the respective Mode 2 UEs in NR or mode 4 UEs in LTE are outside of the coverage 150 of a base station, rather, it means that the respective Mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 150 shown in FIG. 2(a), in addition to the NR Mode 1 or LTE Mode 3 UEs 152, 154 also NR Mode 2 or LTE mode 4 UEs 156, 158, 160 are present. In addition, FIG. 2(b), schematically illustrates an out of coverage UE using a relay to communicate with the network. For example, the UE 160 may communicate over the sidelink with UE1 which, in turn, may be connected to the gNB via the Uu interface. Thus, UE1 may relay information between the gNB and the UE 160

Although FIG. 2(a) and FIG. 2(b) illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements for user devices carrying out sensing across frequency.

### SUMMARY

An embodiment may have a user device, UE, for a wireless communication network, wherein a set of resources is provided for a communication in the wireless communication network, and wherein the UE is to operate, e.g., carry out sensing, only on one or more subsets of frequency resources of the set of resources, wherein a number of frequency resources of the subset of frequency resources is less than a total number of frequency resources of the set of resources.

Another embodiment may have a wireless communication network, comprising one or more user devices, UEs, according to the invention.

Another embodiment may have a method of operating a user device, UE, in a wireless communication network, the method comprising: providing a set of resources for a communication in the wireless communication network, and operating the UE, e.g., carrying out sensing, only on one or more subsets of frequency resources of the set of resources, wherein a number of frequency resources of the subset of frequency resources is less than a total number of frequency resources of the set of resources.

### BRIEF DESCRIPTION OF THE DRAWINGS

Embodiments of the present invention will be detailed subsequently referring to the appended drawings, in which:

FIGS. 1(a) and 1(b) are schematic representation of an example of a terrestrial wireless network, wherein FIG. 1(a) illustrates a core network and one or more radio access networks, and FIG. 1(b) is a schematic representation of an example of a radio access network RAN;

FIGS. 2(a) and 2(b) schematic represent in-coverage and out-of-coverage scenarios, wherein FIG. 2(a) is a schematic representation of an in-coverage scenario in which two UEs directly communicating with each other are both connected to a base station, and FIG. 2(b) is a schematic representation of an out-of-coverage scenario in which the UEs directly communicating with each other,

FIG. 3 schematically illustrates the concept of bandwidth parts;

FIG. 4 illustrates the resource reservation in time using a TRIV value indicated in an SCI received at a UE;

FIG. 5 illustrates a resource reservation in time and frequency using a TRIV value and a FRIV value indicated in an SCI received at a UE;

FIG. 6 illustrates the resources reservation for a further transport block using an SCI associated with an earlier transport block;

FIG. 7 is a schematic representation of a wireless communication system including a transmitter, like a base station, one or more receivers, like user devices, UEs, and one or more relay UEs for implementing embodiments of the present invention;

FIG. 8 illustrates an embodiment of a user device, UE, operating in accordance with the teachings described herein;

FIG. 9 illustrates an embodiment of the present invention in accordance with which operation of a UE, like the UE of FIG. 8, is limited to a bandwidth part within a larger bandwidth part;

FIG. 10 illustrates an embodiment of the present invention sharing common resources a sub-BWP;

FIG. 11 and FIG. 12 illustrates frequency hopping of a sub-BWP within a defined resource pool in accordance with embodiment of the present invention,;

FIG. 13 illustrates a further embodiment for frequency hopping of a monitored part or sub-BWP of a RP;

FIG. 14 illustrates an embodiment in accordance with which two UEs, which operate in accordance with the present invention, are assumed to operate on two different sub-BWPs;

FIG. 15 illustrates an embodiment for an offset indication in a SCI in accordance with embodiments of the present invention;

FIG. 16 illustrates an embodiment for an offset indication of a RP defined in a sub-BWP with reference to another RP starting outside the sub-BWP;

FIG. 17(a) illustrates a SL-resource pool information element in accordance with embodiments of the present invention;

FIG. 17(b) illustrates a table explaining the fields of the SL-resource pool information element of FIG. 17(a);

FIG. 18(a) illustrates a SL BWP-Config information element in accordance with embodiments of the present invention;

FIG. 18(b) illustrates a table explaining the fields of the SL-resource pool information element of FIG. 18(a);

FIG. 19 illustrates an embodiment for determining a sensing frequency region, SFR, within a short sensing window, SSW, using a decision time period; and

FIG. 20 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

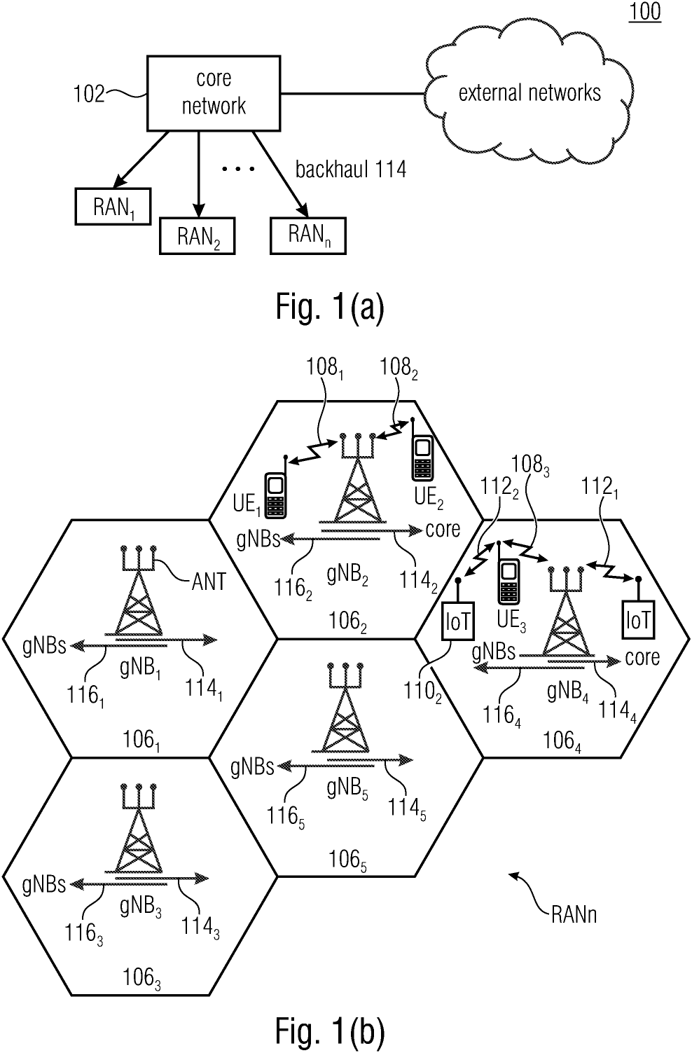

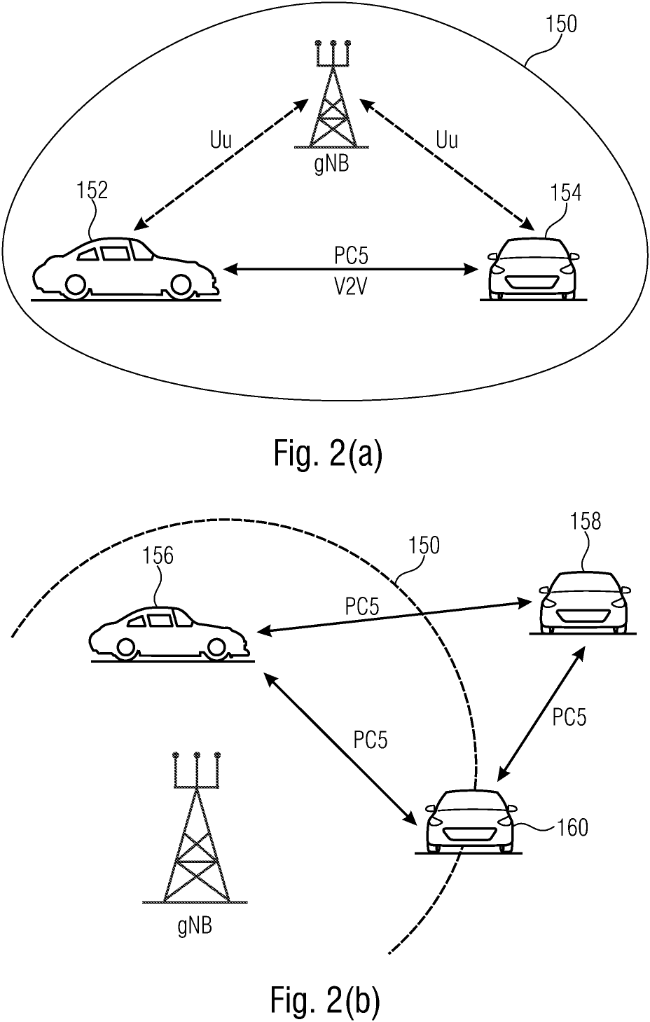

In a wireless communications network, like the one described above with reference to FIG. 1, several types or categories of user devices or UEs may be employed. For example, there are so-called full-powered UEs that are provided with a permanent power supply, like vehicular UEs obtaining power from a vehicles battery. For such UEs, energy consumption is not an issue. Other user devices or UEs, like hand-held UEs, do not have a permanent power supply but are battery driven so that energy consumption needs to be considered. Also, there may be so-called Reduced Capability, RedCap, user devices or UEs having less capabilities when compared to other UEs, e.g., to enhanced Mobile BroadBand, eMBB, UEs. The capabilities concerned may include a maximum bandwidth such a UE may support. For example, when operating in Frequency Range 1, FR1, the UE may support a maximum of 20 MHz bandwidth, and when operating in Frequency Range 2, FR2, the UE may support up to 100 MHz bandwidth. Further requirements of a RedCap UE may include one or more of the following:
Device complexity: reduced costs and complexity when compared to high-end eMBB and Ultra Reliable Low Latency Communication, URLLC, devices.
Device size: for most use cases, device design with compact form factor is needed.
Deployment scenarios: support of all FR1/FR2 bands for Frequency Division Duplexing, FDD, and Time Division Duplexing, TDD.

RedCap UEs may comprise also industrial sensors or wearables using SL communication to communicate with other UEs directly. For example, wearables may use SL communication to communicate with cars, other UEs, such as handsets, or other wearables directly.

For a direct communication in a wireless communications network, like the one described above with reference to FIG. 1, like a device-to-device, D2D, communication or for a vehicle-to-everything, V2X, communication, the concept of resource pools may be used, i.e., the system or network may provide a set of resources, referred to in the following as a sidelink pool or sidelink resource pool, to be used by user devices within the network for a V2X communication. For example, the sidelink pool may be a set of resources configured by a base station so that a user device may use the resources of the sidelink pool exclusively for V2X communications. For example, separate sidelink resource pools may be defined which are used for Mode 1 and Mode 2 resource allocation modes. Sidelink resource pools may be defined within sidelink bandwidth parts, SL-BWPs. BWPs are defined for the sidelink in a similar way as for the uplink/downlink, UL/DL, to provide a convenient way to specify aspects relating to a UEs RF hardware chain implementation. Due to the wide bandwidth operation of these systems, it is vital for UEs to be able to transmit and receive in a frequency range which is a subset of the entire bandwidth. In particular, the UE only has to perform decoding on a smaller bandwidth part. This saves energy and thus battery power, especially since the power consumption of an analog-to-digital converter, ADC, scales with the size of the bandwidth.

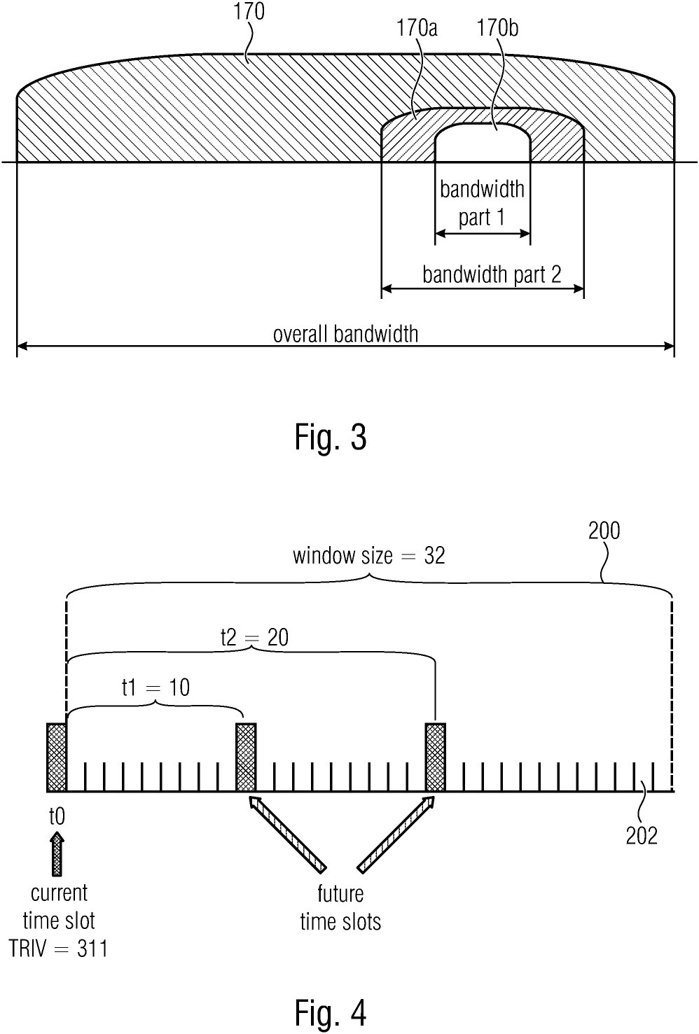

FIG. 3 schematically illustrates the concept of bandwidth parts and illustrates at 170 the overall bandwidth available, as well as two bandwidth parts 170a and 170b having a bandwidth being less than the overall bandwidth 170. A BWP includes a set of continuous resource blocks within the entire bandwidth of the system, and each BWP is associated with a specific numerology, like a sub carrier spacing, SCS, and a respective sidelink prefix. A BWP may be equal or larger than the size of a synchronization sequence, SS, block, also referred to as SSB, and may or may not contain the SSB. A UE is configured with one active sidelink BWP when in connected mode to a gNB, which is the same as the single sidelink BWP used for idle mode or out-of-coverage operation. The subcarrier spacing used on a sidelink is provided in the sidelink BWP configuration or pre-configuration, from the same set of values and associations to frequency ranges as for the Uu interface, e.g., 15, 30, or 60 kHz for FR1, and 60 or 120 kHz for FR2. Sidelink transmission and reception for a UE are thus contained within a sidelink BWP, and the same sidelink BWP is used for both transmitting and receiving. This means that resource pools, S-SSB, etc. are also contained within an appropriate sidelink BWP from the UE’s perspective.

Each sidelink resource pool configuration may contain a maximum number of resources that may be reserved and indicated in a control message or control information, like the sidelink control information, SCI, that is associated with a certain transmission to be transmitted between user devices over the sidelink using resources from the sidelink resource pool. For example, the maximum number of resources that may be reserved and indicated in the SCI may be restricted to two or three resources. The resources include in the time domain respective time slots or symbols, and in the frequency domain respective subcarriers. Resources may be located with one or more active bandwidth parts, BWPs, whereas a BWP is a subset of contiguous common resource blocks, CRBs, for a given numerology on a given RF carrier. Note, the used resources may be as large as the BWP, may be less, or may be adjusted adaptively according to the operational conditions of the given UE. In this specification, a resource may be one or more of a time resource, a frequency resource, a spatial resource, and a code resource, including, for example, a subchannel, a radio frame, a subframe, a time slot, a resource block, RB.

In view of this limitation of reservable resources, the SCI may include a single time and frequency resource assignment field to indicate the resources. The size of the time resource assignment field may vary, for example it may be 5 bits if the number of resources indicated is only two resources, while it is 9 bits if the number of resources indicated is three resources. The size of the frequency resource assignment field may also vary, for example it may be 8 bits if the number of resources indicated is only two resources, or it is 13 bits if the number of resources indicated is three resources. Dependent on the size of this field, a receiving UE, i.e., a UE receiving a transmission associated with a SCI, which indicates in the time and frequency resource assignment field the resources reserved, is able to determine the number of resources that are indicated by the SCI.

For example, the time and frequency resource assignment field in the SCI indicates a time resource indication value, TRIV, and a frequency resource indication value, FRIV. In case the SCI includes a TRIV, the receiving UE may derive one or two values, corresponding to one or two resources in the future or further time slots, dependent on the size of the field, apart from the time slot in which the receiving UE receives the SCI, and the PSSCH attached to the time slot is the occurrence of the first resource. Using the TRIV values, the values t1 and t2 may be obtained, where t1 is the time between a current time slot in which the SCI was received and a second time slot, and t2 is the time between the current time slot and a third time slot. For example, if the TRIV has a length of 5 bits, indicating two resources, the resources on which the receiving UE expects receiving a transmission or transport block, TB, is a resource in the current time slot and a resource in the t1 time slot. If the TRIV has a length of 9 bits, thereby signaling three resources, the receiving UE derives both t1 and t2 using a formula as determined in the associated specification of the 3GPP standard TS 38.214 so as to determine the two future or further time slots in addition to the current time slot in which the SCI was received. The values t1 and t2 are restricted to be within a certain window, also referred to as a reservation window, having a size of, for example, 32 time slots. From the single TRIV value, the receiving UE may determine a single value pair of t1 and t2, and the following table give some non-exhaustive examples for TRIV values and the value pairs t1, t2 that may be derived.

| TRIV Value | t1 | t2 |
|---|---|---|
| 32 | 1 | 2 |
| 61 | 30 | 31 |
| 91 | 1 | 31 |
| 311 | 10 | 20 |
| 371 | 10 | 22 |
| 403 | 12 | 25 |
| 482 | 1 | 17 |

Thus, when considering a t1 value of 10 ms and t2 value of 20 ms, the resource reservation is signaled by a TRIV value of 311 within the SCI. When receiving such a SCI, the receiving UE determines the current time slot and the future time slots, as illustrated in FIG. 4, which illustrates the resource reservation in time using a TRIV value 311 indicated in an SCI received at a UE and the values t1 and t2 derived from the TRIV value 311. As may be seen from FIG. 4, the window 200 starts at a current time slot t0, at which the SCI associated with the transmission is received at a receiving UE. In the example of FIG. 4, the window 200 has a window size of 32 time slots 202. The SCI, in the example, includes a TRIV value of 311 on the basis of which the receiving UE determines that the value of t1 is 10 ms and the value of t2 is 20 ms. Thus, the receiving UE is aware that in addition to the current time slot, also time slots t1 and time slots t2 are reserved for a retransmission or a transport block by the UE that was sending the initial SCI associated with the initial transport block.

In case the SCI includes a TRIV and a FRIV, in the time slots indicated by the TRIV, the RX UE may will derive, depending on the size of the FRIV field, one or two values, which correspond to the subchannels in the one and two resources in the future or further time slots, respectively, and indicate, apart from one or more subchannels in which the RX UE received the SCI, additional resources where a PSSCH associated with the SCI occurs. The values indicate the starting subchannel indices for the 1 or 2 future resources, denoted by

$${n}_{s u b C H , 1}^{s t a r t} \text{and} {n}_{s u b C H , 2}^{s t a r t}$$

respectively, in the time slots t1 and t2 derived from the TRIV. Using the starting indices, and resource pool specific parameters such as the number of contiguously allocated sub-channels for each of the resources, denoted by L_{subCH}, and the number of subchannels defined for the given resource pool, denoted by

$${N}_{\text{subchannel}}^{S L} ,$$

the RX UE may determine the exact subchannels where the transmissions associated with the SCI are carried out. For example, if the FRIV received in the SCI is 9 bits long, the RX UE determines that the expected transmission will occur in the current subchannel where the SCI was received, as well as in a future time slot, indicated by t1, in the subchannels starting from

$${n}_{s u b C H , 1}^{s t a r t}$$

and spanning L_{subCH} subchannels. The TX UE determines this FRIV using the following formula, as seen in TS38.214:

$$F R I V = {n}_{s u b C H , 1}^{s t a r t} + {\sum }_{i = 1}^{{L}_{s u b C H} - 1} \left({N}_{s u b c h a n n e l}^{S L} + 1 - i\right)$$

If the FRIV received in the SCI is 13 bits long, the RX UE can determine that the expected transmission will occur in the current time slot and subchannel(s) where the SCI was received, as well as in 2 future time slots, indicated by t1 and t2, in the subchannels starting from

$${n}_{s u b C H , 1}^{s t a r t} \text{and} {n}_{s u b C H , 2}^{s t a r t}$$

respectively, spanning L_{subCH} subchannels. The TX UE determines this FRIV using the following formula, as seen in TS38.214:

$$\begin{matrix}F R I V = {n}_{s u b C H , 1}^{s t a r t} + {n}_{s u b C H , 2}^{s t a r t} ⋅ \left({N}_{\text{subchannel}}^{S L} + 1 - {L}_{s u b C H}\right) + \\ {\sum }_{i = 1}^{{L}_{s u b C H} - 1} {\left({N}_{\text{subchannel}}^{S L} + 1 - i\right)}^{2}\end{matrix}$$

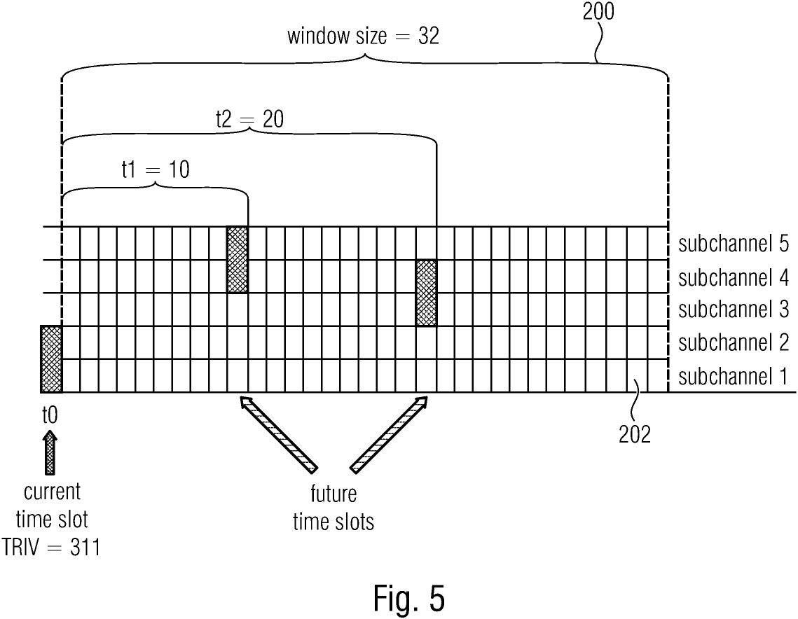

FIG. 5 illustrates a resource reservation in time and frequency using a TRIV value 311 indicated in an SCI received at a UE and the values t1 and t2 derived from the TRIV value 311. The TRIV used is 311, indicating a t1 value of 10 ms and a t2 value of 20 ms. In a resource pool having

$${N}_{\text{subchannel}}^{S L} = 5$$

subchannels, the number of contiguously allocated sub-channels for each of the resources L_{subCH} is 2 subchannels, and the starting indices vary. In the example of FIG. 5, the starting index is subchannel 1 for the initial transmission at the current time slot t0, 4 for the second resources at t1, and 3 for the third resource at t2. Thus, the receiving UE is aware that in addition to the current time slot in subchannels 1 and 2, in time slot t1 subchannels 4 and 5 and in time slots t2 subchannels 3 and 4 are reserved for a transmission or a transport block by the UE that was sending the initial SCI associated with the initial transport block.

Another resource pool specific feature is the possibility to reserve, during an initial transmission of a transport block, TB1, resources for a further transport block, TB2, using the SCI associated with the earlier transport block, TB1. This feature may be limited to Mode 2 UEs and may be indicated by a parameter sl-MultiReserveResource. In case such a feature is enabled, the UE may reserve the same resources indicated by the values t1 and t2 also for the later transport block TB2, for example after a certain time period referred to as the resource reservation period that may be indicated in the SCI associated with the TB1. The value for the resource reservation period may be selected from a higher layer parameter sl-ResourceReservePeriodList that may contain 16 values configured per resource pool. These values are determined from:
a list1 of possible periods {ms0, ms100, ms200, ms300, ms400, ms500, ms600, ms700, ms800, ms900, ms1000}, wherein ms0 indicates that this feature is disabled,
a list2 of possible periods {1..99}.

When a UE carries out a transmission, one among the 16 values, which are configured for the resource pool, may be indicated in a first stage SCI, for example using the SCI format 1-A, by the “resource reservation period” parameter. The SCI formal 1-A may contain three time/frequency indications for resources, indicated by the TRIV and FRIV, namely
time/frequency indications with respect to a current time slot used for TB1,
time/frequency indications with respect to the current time slot plus the indicated resource reservation period that are used for TB2.

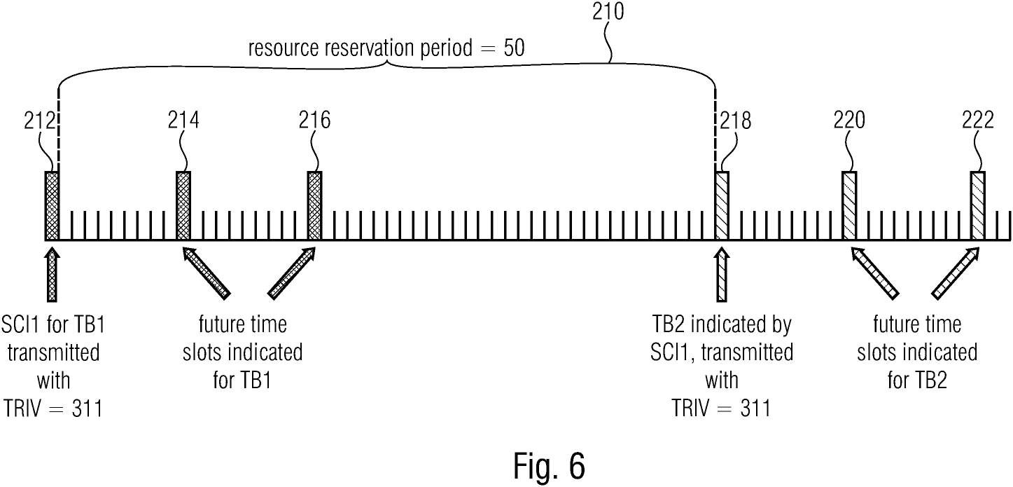

FIG. 6 illustrates an example for the reservation of resources for a further transport block, TB2, using an SCI 1 associated with an earlier transport block TB1. FIG. 6 assumes a resource reservation period 210 having a duration of 50 ms, which is defined in the initial SCI1 received at 212 for a first transport block TB1 that is transmitted by a transmitting UE. The SCI indicates a TRIV value of 311, thereby indicating the future time slots 214 and 216 at which transmissions of the transmitting UE occur. Further, based on the reservation period 210, the UE further determines, without sensing, the time slots 218 to 222 as further transmission occurrences by the transmitting UE for transmitting the further transport block, TB2.

In case this feature is disabled, the maximum number of resources defined in a SCI is fixed to three resources. Apart from reserving resources for another TB, resources may also be reserved in a periodic manner in a similar way as is done in LTE for Semi Persistent Scheduling, SPS, transmissions. In this case, the interval of the periodicity may be indicated by the higher layer parameter P_{rsvp_TX}, and the value may be selected from one among the allowed values indicated in the sl-ResourceReservePeriodList. Based on this periodicity, the same set of up to three time/frequency resources may be reserved for periodic transmissions at the given interval, and a counter for the number of times the periodic transmission is repeated may be maintained by the parameter Cᵣₑₛₑₗ.

The indication of the resources in time and frequency is carried out both for Mode 1 and Mode 2 transmissions. In Mode 1, a UE may carry out sensing, e.g. to generate a sensing report, like an occupancy report, to be reported to a base station or another UE, for example a group leader UE. In Mode 2, a UE may autonomously carry out resource selection and allocation by sensing. For example, in Mode 2, the UE autonomously selects resources using the following steps:
The UE carries out sensing of the entire sidelink pool, i.e., all resources of the sidelink pool are sensed. At each instance n in time, e.g., at each time slot, the UE senses all resources of the sidelink pool. For example, when considering a sidelink resource pool where a UE intends to transmit, a sensing window having time resources spanning a period between 100 ms and 1100 ms is defined prior to the transmission. The UE takes into consideration the sensing results within the sensing window for the said transmission. The size of the sensing window may be set by the network and defined by the specification of the 3GPP standard TS 38.331, indicated by the parameter s1-sensingwindow-r16 in the information element SL-ResourcePool, and may take a range of values between 100 ms and 1100 ms. For example, for certain UEs, the sensing window may have a duration of 1000 ms or time slots. The UE carries out sensing in all the slots of the resource pool by comparing a Reference Signal Received Power, RSRP, measurement in resources in the respective time slots to a predefined RSRP threshold, to determine whether the resource is available to use for potential transmissions or not.
Based on the sensing results, the UE excludes sidelink pool resources which it determines to be reserved by other UEs.
Following the sensing and exclusion of reserved resources, the UE selects final resources to be used for its transmission within a selection window following the time slot n.

Once the resources are selected, the UE may utilize the resource in a current time slot and may reserve future resources by sending an SCI associated with the transmission indicating via the TRIV value and FRIV value, for example, the future or further resources to be used, as explained with reference to FIG. 4 to FIG. 6.

As described above, UEs operate, for example, within a BWP over all subchannels at respective time slots, for example for performing transmissions or for carrying out a sensing of available resources. However, operations on all subchannels, like performing a sensing on all the subchannels of a sidelink pool or a bandwidth part, which involves the above-described measurements and comparison operations, goes together with a substantial consumption of power. While this may not be an issue for full-powered UEs, like vehicular UEs, which may rely on a power source of the vehicle in which they are implemented, D2D or V2X communications may not be limited to such vehicular use cases. Also public safety and commercial use cases are to be considered in which the user device, UE, like a pedestrian UE, P-UE, is battery operated so that power efficiency is an issue. In addition, the above-described UEs with a reduced capability need to be considered. However, when applying conventional approaches, UE is needed to operate over an entire bandwidth part or all frequency resources of a resource pool so that the battery may drain quickly by such operation, like a sensing operation.

Therefore, in accordance with the present invention, improvements and enhancements for UEs, like battery-operated UEs, are provided so as to allow such UEs to operate in an efficient manner, while, at the same time, not consuming the same amount of energy as a full-powered UE. Embodiments of the inventive approach allow a UE to perform a power effective sensing operation for selecting and allocating resources or for generating an occupancy report which avoid a power consumption as experienced by a full-powered UE.

The present invention achieves such an efficient and power saving operation by reducing or restricting operation of the UE, like a sensing operation, across frequency, for example by not operating or sensing on all frequency resources, like subchannels of a resource pool or a bandwidth part but only on a subset of the frequency resources. In other words, when considering the overall number of frequency resources, like subchannels, in a predefined set of resources, like a bandwidth part or a resource pool, the overall number of frequency resources of the subset of frequency resources, in accordance with the present invention, is lower than the overall number of frequency resources of the resource pool. Stated differently, the subset bandwidth spanned by the subset of frequency resources is shorter than the overall bandwidth of the set of resources, like the bandwidth part or a resource pool.

Thus, in accordance with the inventive approach, enhanced power saving capabilities for a UE, like a low power UE or a reduced capability UE or any other kind of UE, may be achieved by operating the UE only on a subset of frequency resources, for example carrying out sensing only on such a subset of frequency resources. The subset of frequency resources is within a defined set of resources across frequency, like a subset of the frequency resources across a full bandwidth as provided by the wireless communication network, or a subset of the frequency resources as defined by a bandwidth part or a resource pool as provided, for example, for carrying out a certain kind of communication like a sidelink communication. The frequency resources may also be referred to as subcarriers or subchannels or resource blocks of the defined set of resources.

In accordance with embodiments, the subset of frequency resources may be a smaller BWP that is defined within a larger BWP, and certain sensing resources across frequency may be provided, which are common to both the smaller and larger BWPs. Other embodiments of the inventive approach address a frequency offset indication by a UE for identifying resource locations, for example by indicating the offset using control information, like a SCI, or by including such offset indication into a resource pool configuration. Yet further embodiments of the inventive approach may be employed together with a so-called short sensing/listening window, SSW/SLW, as is described in more detail in European patent application 20183530.3 filed on Jul. 1, 2020 having the title “Resource Reservation Prediction for Sidelink UEs”, which is incorporated herein by reference. In accordance with such embodiments, operating the UE only within the reduced frequency range within a resource pool or a bandwidth part may be implemented together with a short sensing/listening window. In accordance with yet other embodiments, a minimum sensing set of resources across frequency may be defined.

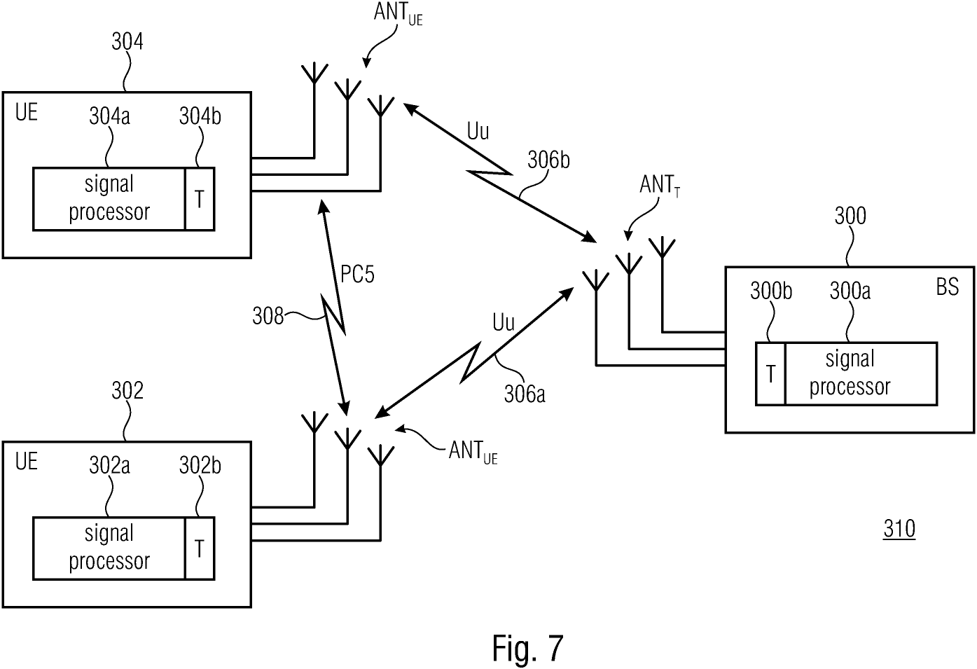

Embodiments of the present invention may be implemented in a wireless communication system as depicted in FIG. 1 including base stations and users, like mobile terminals or loT devices. FIG. 7 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5/sidelink, SL, interface. When the UEs are not served by the base station or are not connected to a base station, for example, they are not in an RRC connected state, or, more generally, when no SL resource allocation configuration or assistance is provided by a base station, the UEs may communicate with each other over the sidelink, SL. The system or network of FIG. 7, the one or more UEs 302, 304 of FIG. 7, and the base station 300 of FIG. 7 may operate in accordance with the inventive teachings described herein.

### UE

The present invention provides a user device, UE, for a wireless communication network,
wherein a set of resources is provided for a communication in the wireless communication network, and
wherein the UE is to operate, e.g., carry out sensing, only on one or more subsets of frequency resources of the set of resources, wherein a number of frequency resources of the subset of frequency resources is less than a total number of frequency resources of the set of resources.

In accordance with embodiments, outside the one or more subsets of frequency resources the UE is not to operate, e.g., not to carry out one or more of the following:
sensing,
data transmission and/or reception.

In accordance with embodiments, a further set of resources is provided in the wireless communication network for a communication, and wherein the UE is to operate on some or all of the further set of resources.

In accordance with embodiments, the UE is to operate on a plurality of subsets of frequency resources, the plurality of subsets of frequency resources being contiguous or being separated, e.g., by respective non-sensing-intervals.

In accordance with embodiments,
the UE is to operate in a first mode and in a second mode,
in the first mode, the UE is to operate on all frequency resources of the set of resources,
in the second mode, the UE is to operate only on the one or more subsets of frequency resources of the set of resources, and
responsive to one or more criteria or events, the UE is to switch between the first mode and the second mode.

In accordance with embodiments, the one or more criteria or events comprise one or more of the following:
entering a power saving mode, which causes the UE to switch from the first mode to the second mode,
leaving a power saving mode, which causes the UE to switch from the second mode to the first mode,
switching from an RRC_CONNECTED state to an RRC_INACTIVE state, which causes the UE to switch from the first mode to the second mode,
switching from an RRC_INACTIVE state to an RRC_CONNECTED state, which causes the UE to switch from the second mode to the first mode,
a change in QoS, priority, or traffic type for a transmission to be made by the UE,
in case the UE has data to transmit,
in case of a change in motion state of the UE,
in case the UE changes a geographic area,
the UE moving from in coverage to out-of-coverage a base station or from out-of-coverage to in coverage of a base station,
responsive to receiving or sending a trigger via a sidelink.

In accordance with embodiments,
the set of resources defines at least one bandwidth part, BWP, and
the UE is configured or preconfigured with the subset of frequency resources so as to define a sub-bandwidth part, sub-BWP, within the BWP.

In accordance with embodiments, the set of resources defines at least one resource pool, RP, the RP comprising a plurality of time resources and a plurality of frequency resources.

In accordance with embodiments, the RP comprises a RP for a PC5 sidelink, SL, communication, e.g., a SL transmit pool, SL-TX-RP, or a SL receive pool, SL-RX-RP, or a SL transmit and receive pool, SL-TX/RX-RP.

In accordance with embodiments,
the at least one RP comprises a plurality of time and frequency resources, and
the UE is configured or preconfigured with a frequency resources of the RP so as to define a bandwidth part, BWP, that is located partially or fully within the RP.

In accordance with embodiments, the UE is configured or preconfigured with a sub-resource pool, sub-RP, the sub-RP being located at least partially within the BWP and some or all of the time resources of the RP.

In accordance with embodiments, in case of a transmission, the UE is to transmit a control information, like a SCI, indicating resource locations of the transmission in the sub-RP, the control information including a frequency offset parameter indicating that resource locations in the control information are indicated with respect to the sub-RP.

In accordance with embodiments, the control information further includes a resource pool ID parameter identifying the sub-RP.

In accordance with embodiments, the control information is a 1^{st} or a 2^{nd} stage sidelink control information, SCI, carrying the frequency offset and the resource pool ID parameters.

In accordance with embodiments, when configuring or preconfiguring the UE with the sub-RP, a start subchannel of the sub-RP is indicated
by an offset with respect to a predefined subchannel or resource block, RB, of the RP, like a start subchannel of the RP, or
by the subchannel or the resource block, RB, of the RP corresponding to the start subchannel or RB of the sub-RP.

In accordance with embodiments, a configuration message for configuring the sub-RP comprises
a sl-startSubchannelOffset parameter indicating the first subchannel that is within the sub-RP, or
a sl-startResourcePoolOffset parameter indicating the offset between an initial resource block, RB0, of the RP and an initial resource block, RB0, of the sub-RP.

In accordance with embodiments,
the at least one RP comprises a first RP and a second RP, each comprising a plurality of time resources and a plurality of frequency resources, and
the UE is configured or preconfigured with a subset of the frequency resources of the first and second RPs so as to define a bandwidth part, BWP.

In accordance with embodiments, the BWP overlaps with the first and second RPs.

In accordance with embodiments, the first and second RPs are contiguous and non-overlapping or at least partially overlapping in the frequency domain.

In accordance with embodiments, the UE is configured or preconfigured with a frequency hopping pattern, the frequency hopping pattern causing the BWP to hop over time.

In accordance with embodiments, the RP contains a subset of common resources, the subset of common resources being common resources which are to be monitored by all UEs using the RP.

In accordance with embodiments, the UE is to use the subset of common resources for transmitting data to another UE which monitors only the subset of frequency resources.

In accordance with embodiments, the UE is capable to operate in a first frequency range or supports a first maximum bandwidth, the first frequency range or first maximum bandwidth being less than a second frequency range or a second maximum bandwidth of one or more further UEs operating in set of resources.

In accordance with embodiments,
the set of resources comprises a plurality of time and frequency resources, and
the UE is to carry out sensing only on one or more subsets of time resources of the set of resources, wherein a number of time resources of the one or more subsets is less than the total number of time resources within the set of resources provided by the network.

In accordance with embodiments, outside the one or more subsets of time resources the UE is not to carry out one or more of the following:
sensing,
data transmission and/or reception,
switching between reception and transmission,
switching between transmission and reception.

In accordance with embodiments, the UE is to carry out sensing on a plurality of subsets of time resources, the plurality of subsets of time resources being separated by respective non-sensing-intervals.

In accordance with embodiments, the UE is to carry out sensing only on certain frequency resources of the subset of frequency resources.

In accordance with embodiments, the UE is to carry out sensing in one or more sensing frequency regions, SFRs, the SFR comprising only the certain frequency resources of the subset of frequency resources.

In accordance with embodiments,
the UE is to receive from the wireless communication network the SFR, or
the UE is to receive the SFR from another UE via sidelink, or
the UE is to determine the SFR.

In accordance with embodiments, to determine the SFR, the UE is to
carry out sensing across all frequency resources for detecting a pattern of frequency resources to be used for transmissions by other UEs, and/or
using the sensing results, define the SFR.

In accordance with embodiments, the SFR is defined to include a plurality of frequency resources, the plurality of frequency resources being contiguous or being separated by respective non-sensing-intervals.

In accordance with embodiments, the SFR is defined using one or more of the following parameters:
a starting RB or subchannel index,
a contiguous set of RBs or subchannels,
a pattern across frequency,
a pattern across frequency and time.

In accordance with embodiments, the SFR is defined as a pattern across frequency using one or more of the following parameters:
the resources across a frequency of the set of resources in which the UE is to carry out sensing,
the resources across a frequency of the set of resources in which the UE is not carrying out sensing,
the frequency gap or offset between two consecutive subsets of frequency resources where the UE is to carry out sensing,
a periodicity of the frequency pattern,
an overall frequency band for which the frequency pattern repeats.

In accordance with embodiments, the UE is to carry out sensing across all frequency resources for a decision time period, the decision time period being
based on an absolute number of time slots within which the UE is to carry out sensing of all frequency resources, or
defined as a number of subsets of time resources of the set of resources within which the UE carries out sensing of all frequency resources.

In accordance with embodiments, the decision time period is repeated periodically.

In accordance with embodiments, the SFR depends on a subchannel detection rate, SCDR, the SCDR being defined as a number of frequency resources or subchannels where the UE is to carry out sensing to a total number of frequency resources or subchannels in the subset of frequency resources.

In accordance with embodiments, the UE is to alter the SCDR depending on one or more criteria, which may include one or more of the following:
a priority of a transmission for which the UE is carrying out sensing,
a congestion status of the set of resources,
a power status of the UE,
a service type, e.g. PPDR services or pedestrian services, for which the UE is configured or preconfigured to use or cater to,
a change in QoS, priority, or traffic type for a transmission to be made by the UE,
in case of a change in motion state of the UE,
in case the UE changes a geographic area,
the UE moving from in coverage to out-of-coverage a base station or from out-of-coverage to in coverage of a base station, e.g., when changing from one resource pool configuration to another,
responsive to receiving or sending a trigger via a sidelink.

In accordance with embodiments,
the UE is configured or pre-configured with a lookup table, the lookup table mapping the SCDR to a congestion status of the set of resources,
using the congestion status and the lookup table, the UE is to determine a priority of transmissions that the UE is capable to transmit.

In accordance with embodiments, the UE is configured or preconfigured with one or more minimal sets of frequency resources from the subset of frequency resources, and wherein the UE is expected to sense and monitor the minimal set of frequency resources.

In accordance with embodiments, the UE is to sense and monitor at least the minimal set of frequency resources at certain time intervals.

In accordance with embodiments, the time intervals are derived from:
a DRX configuration, or
a search space, or
a DRX_ON duration.

In accordance with embodiments, the one or more minimal sets of frequency resources are defined on a service type, a cast type, a priority associated with a transmission.

In accordance with embodiments, the user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, or a mobile terminal, or a stationary terminal, or a cellular IoT-UE, or a vehicular UE, or a vehicular group leader (GL) UE, or an IoT or narrowband loT, NB-IoT, device, a wearable, a reduced capability (RedCap) device, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

### Network

The present invention provides a wireless communication network, comprising one or more of the inventive user devices, UEs.

In accordance with embodiments, the wireless communication network further comprises one or more further UEs or an entity of the core network or the access network of the wireless communication network.

In accordance with embodiments, the entity of the core network or the access network comprises one or more of the following: a macro cell base station, or a small cell base station, or a central unit of a base station, or a distributed unit of a base station, or a road side unit, RSU, or an AMF, or an MME, or an SMF, or a core network entity, or mobile edge computing, MEC entity, or a network slice as in the NR or 5G core context, or any transmission/reception point, TRP, enabling an item or a device to communicate using the wireless communication network, the item or device being provided with network connectivity to communicate using the wireless communication network.

### Methods

The present invention provides a method of operating a user device, UE, in a wireless communication network, the method comprising:
providing a set of resources for a communication in the wireless communication network, and
operating the UE, e.g., carrying out sensing, only on one or more subsets of frequency resources of the set of resources, wherein a number of frequency resources of the subset of frequency resources is less than a total number of frequency resources of the set of resources.

### Computer Program Product

Embodiments of the present invention provide a computer program product comprising instructions which, when the program is executed by a computer, cause the computer to carry out one or more methods in accordance with the present invention.

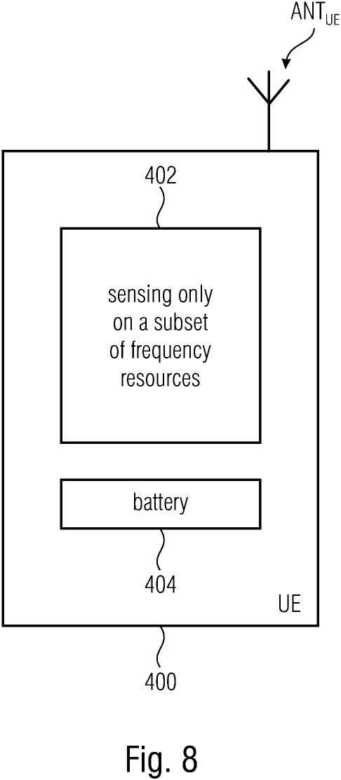

FIG. 8 illustrates an embodiment of a user device, UE, operating in accordance with the teachings described herein. The UE 400 may be located within a wireless communication system or network as described above and may operate in Mode 1 or in Mode 2 or may operate as a reduced capability UE. The wireless communication network may provide a set of resources for a communication, like a bandwidth part defining a plurality of frequency resources, like subcarriers or subchannels, to be used for a communication, or a resource pool defining a set of time and frequency resources to be used for a communication. In accordance with the inventive approach, UE 400 operates, as is indicated in FIG. 8 at 402, only on one or more subsets of the frequency resources of the set of resources, for example the UE carries out sensing only on one or more subsets of the subcarriers or subchannels as defined by a bandwidth part or by the frequency resources of a resource pool. Thus, the number of frequency resources of the subset of frequency resources is less than a total number of frequency resources of the set of resources provided by the network. Thus, operation of the UE, which may include a battery 404, is limited to a subset of frequency resources, thereby allowing power savings as not all subchannels subcarriers need to be monitored thereby avoiding, for example, a quick drainage of the battery 404. Outside the one or more subsets the UE does not operate. For example, outside a subset of frequency resources, the UE does not carry out sensing, does not perform a data transmission and/or reception, does not switch between reception and transmission or between transmission and reception. In accordance with embodiments, the UE may operate on a plurality of subsets of frequency resources which may be continuous or separated by inactive intervals or bandwidths at which no operation occurs, like non-sensing intervals. In accordance with embodiments, the frequency resources used for sensing may also have a comb structure within the subset of frequency resources.

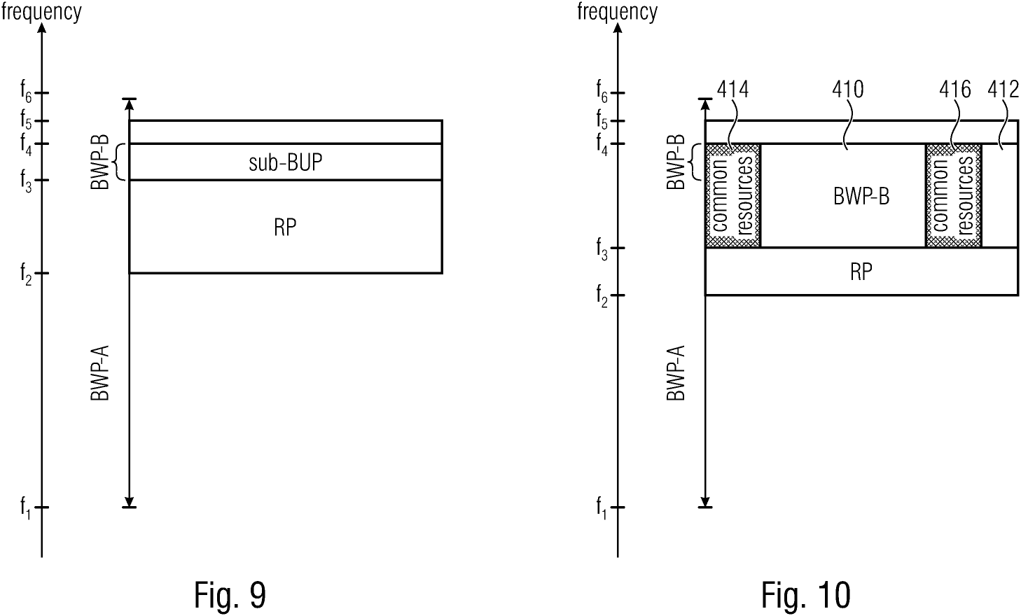

FIG. 9 illustrates an embodiment of the present invention in accordance with which operation of a UE, like UE 400 of FIG. 8, is limited to a bandwidth part within a larger bandwidth part. FIG. 9 illustrates the frequency resources along the vertical direction, and within the available frequency resources the wireless communication system may define a first, larger bandwidth part BWP-A to be used for a certain kind of communication, like a sidelink communication of the UE 400 in FIG. 8 with one or more other UEs in the system. In accordance with the inventive approach, rather than operating on the entire BWP-A, operation is limited or restricted to the smaller bandwidth part BWP-B that is within the larger BWP-A. For example, the UE 400 may be configured or preconfigured with the subset of frequency resources defining BWP-B, thereby reducing or limiting sensing operations to the smaller BWP-B. As is illustrated in FIG. 9, BWP-A extends from a frequency f₁ to frequency f₆, and BWP-B extends within the BWP-A from frequency f₃ to frequency f₄.

For example, the UE may be a certain type of UE, e.g. a reduced capability UE or a power saving UE, that is configured or preconfigured with the subset of frequency resources, and the BWP-B, also referred to as a sub-BWP, is considered by this type of UE to be the only or fill BWP. In other words, such a UE may not be aware that the BWP, it is configured or preconfigured with, is actually only a sub-BWP within a larger BWP or a resource pool. For example, the UE may operate only in the 50 MHz BWP, like BWP-B, that is within a 100 MHz BWP, like BWP-A, but only see BWP-B. It is also possible for the BWP-B to be partially overlapping with BWP-A.

In accordance with embodiments of the inventive approach, the UE 400 may be aware of both BWPs, e.g., it may be configured or preconfigured BWP-A and BWP-B. Such a UE may operate in a first mode and in a second mode. In the first mode, the UE operates on all frequency resources or on all frequencies of BWP-A, while in the second mode the UE operates only on the one or more subsets of frequency resources, for example only on BWP-B. The UE 400 may switch between the first and second modes responsive to one or more criteria or events. The one or more criteria or events may comprise one or more of the following:
entering a power saving mode, which causes the UE to switch from the first mode to the second mode,
leaving a power saving mode, which causes the UE to switch from the second mode to the first mode,
switching from an RRC_CONNECTED stat to an RRC_INACTIVE state, which causes the UE to switch from the first mode to the second mode,
switching from an RRC_INACTIVE state to an RRC_CONNECTED state, which causes the UE to switch from the second mode to the first mode,
a change in a Quality of Service, QoS, a priority, or a traffic type for a transmission to be made by the UE; for example, when the QoS or priority increase by a predefined amount, the UE may switch from the second mode to the first mode, and when the QoS or priority decrease by a predefined amount, the UE may switch from the first mode to the second mode; for example, data traffic, like FTP or VoIP traffic, may have a priority associated with it,
in case the UE has data to transmit, to make sure sufficient resources are available for the transmission, the UE may extend a sensing from the limited frequency resources to all frequency resources, i.e., switch from the second mode to the first mode,
in case a motion state of the UE changes, e.g., when the UE moves from stationary to moving, the UE may switch from the first mode to the second mode, or when a speed with which the UE moves changes, the UE switch from the first mode to the second mode when the speed increases by a predefined amount or switch from the second mode to the first mode when the speed decreases by a predefined amount,
in case the UE change from a first geographic area to a second first geographic area.; for example, a UE may operate on a smaller BWP in rural areas where less car/SL traffic is expected and may change to a larger BWP in urban/congested areas; similarly, a pedestrian UE may reduce or even turn off monitoring in areas without cars (buildings, city parks), and extend monitoring when close to traffic,
the UE, which may be a vehicular UE, moves from in-coverage to out-of-coverage, OoC, of a base station or moves from OoC to in-coverage of a base station and remains in Mode 2; for example, when being OoC a reduced monitoring set may not be used and in-coverage which is under network control, a smaller set may be configured with the UE,
the UE receives a trigger to switch modes, e.g., sidelink from a wearable that pings the UE to relay data, or responsive to sending a trigger to a wearable, e.g. when a software update is available for the wearable; for example, receiving a trigger indicates to the UE that more traffic is to be expected or transmissions outside the smaller BWP are to be expected, hence causing the UE to switch to a larger BWP; accordingly, when no more transmissions are to be expected a trigger can cause a switch to a smaller BWP..

This may also be referred to as a discontinuous reception in frequency, DRF, which is similar to the known DRX defined for the time domain. Thus, in accordance embodiments of the inventive approach, DRX is extended to the frequency domain. In other words, a UE, like UE 400, may have the hardware capabilities to listen to the full bandwidth, like BWP-A, and may use the reduced bandwidth configuration, BWP-B, for operating in the DRF mode. In accordance with embodiments, the DRF mode may be combined with the DRX mode, thereby even further reducing the power consumption.

In accordance with other embodiments, the network may define a BWP, like the BWP-A, to be used for a communication. Further, the network may define the set of resources, like a resource pool, RP, as depicted in FIG. 9, so as to define within the BWP-A certain time resources and certain frequency resources to be used for a communication, like a sidelink communication. In this case, the RP may also be referred to as a sidelink resource pool, SL-RP. The RP, as is depicted in FIG. 9, includes a plurality of time resources and some or all of the frequency resources of BWP-A. More specifically, the RP extends from frequency f₂ to frequency f₅ and, in addition, has a defined duration or number of time slots in the time domain. In other words, across frequency, the RP may span the entire BWP-A or only a part thereof, as is depicted in FIG. 9. In embodiments employing a RP, the UE 400 is configured or preconfigured with the subset of frequency resources so as to define a sub-BWP or BWP-B in the RP, as is depicted in FIG. 9, and the UE only operates in the sub-BWP, for example performs sensing for resources in sub-BWP or only monitors the sub-BWP. It is also possible for BWP-B to be partially overlapping with the RP, and need not be completely within the RP. In accordance with embodiments, BWP-A may have a bandwidth of 20 MHz, and the RP is provided within this 20 MHz bandwidth, and the sub-BWP is defined, as is depicted in FIG. 9, to have a bandwidth smaller than the BWP-A.

In accordance with embodiments implementing the sub-BWP in the RP, as depicted in FIG. 9, the time and frequency resources in the sub-BWP may be exclusively used for operation of a UE, like UE 400 in FIG. 8. UE 400 may exclusively operate in the sub-BWP, i.e., other UEs do not use the sub-BWP.

In accordance with other embodiments, as depicted in FIG. 10, the sub-BWP or BWP-B may be exclusively used by the UE in one or more parts, like parts or portions 410, 412 while other parts, like parts 414 and 416 may be shared with other UEs operating in BWP-A or the RP. More specifically, the UE 400 may use in first parts 410 of the sub-BWP a first number of time resources and some or all frequency resources of the sub-BWP exclusively, while sharing in second parts 414, 416 of the sub-BWP the resources of the sub-BWP and/or the RP with one or more other UEs operating on the resources of BWP-A and/or the RP. Thus, the common resources in parts 414, 416 of the larger BWP-A and the smaller BWP-B are shared by both BWPs and are located within the frequency domain of the smaller BWP-B. For example, a UE, like a reduced capability UE, operating only in BWP-B may decode certain control resource sets, CORESETs, of a control channel of the larger BWP-A. Thus, a UE operating in BWP-B may be aware of other transmissions which are signaled in the common CORESET 414, 416 among both BWPs.

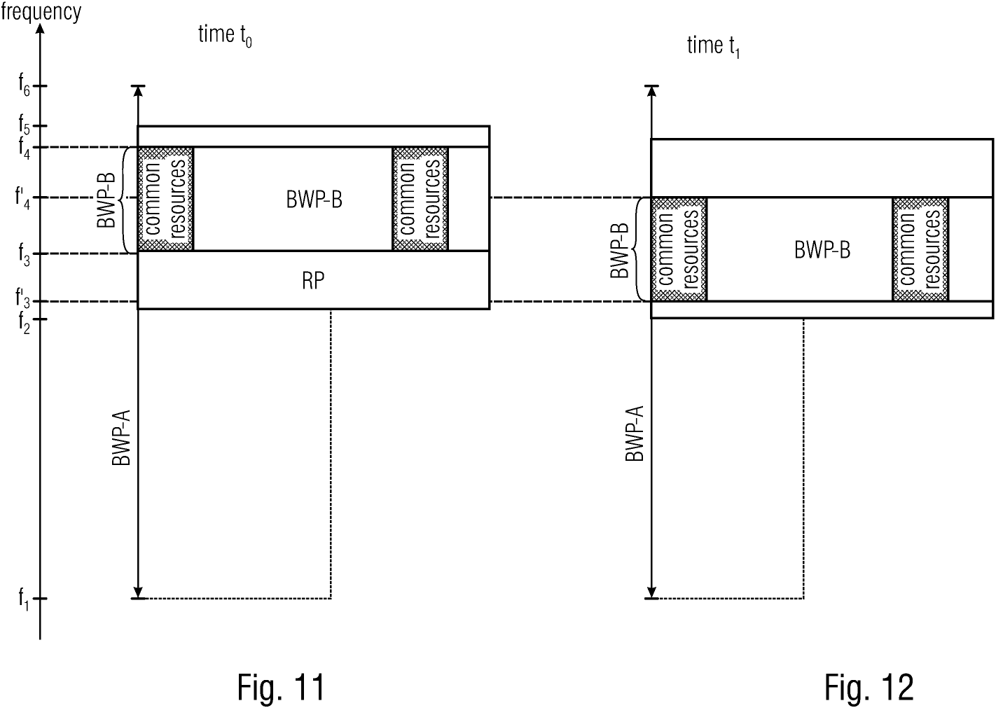

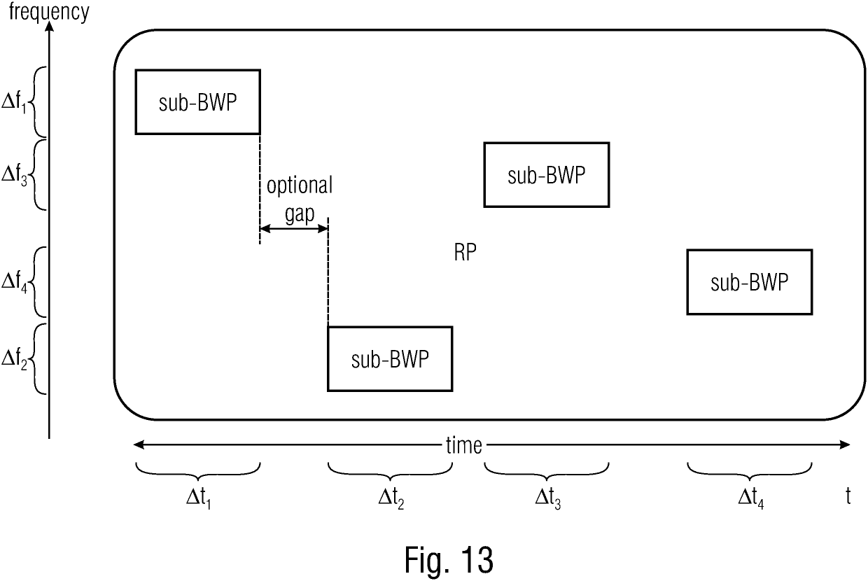

In accordance with further embodiments, for example for reducing or avoiding interference when transmitting on the common resources 414, 416, the UE may be configured or preconfigured with a frequency hopping pattern causing the subset of frequency resources, like BWP-B to hop in frequency over time. FIG. 11 illustrates an embodiment for allowing frequency hopping within a defined resource pool, more specifically, a situation at a time t0 which corresponds to the situation in FIG. 10 in which the BWP-B within the BWP-A extends between frequencies f₃ and f₄. In accordance with the frequency hopping over time, an automatic switching of the frequencies covered by the BWP-B is defined, for example, by a certain hopping pattern, so that, as is depicted in FIG. 12, at a time t1 following the time t0, the BWP-B is at a different position across frequency and spans the frequencies from f₃′ to f₄′. In the embodiment depicted in FIG. 11 and FIG. 12, it may be seen that the BWP-B at time t1 has shifted from a position closer to frequency f₅ to a position closer to frequency f₂. FIG. 13 illustrates a further embodiment for frequency hopping of the monitored part or sub-BWP of a RP. In accordance with the embodiment depicted in FIG. 13, the sub-BWP or part of the RP that is monitored by the inventive UE may be varied over time by hopping in frequency. As is illustrated in FIG. 13, in accordance with embodiments, during a first time period Δt1, the sub-BWP monitored by the UE may be in a first frequency range Δf₁ while, at a second time period Δt2 that either follows immediately the first time period Δt1 or is offset by a gap from the first time period Δt1 the sub-BWP is in a second frequency range Δf₂ different from the first frequency range Δf₁. At later time intervals Δt3 and Δt4, the sub-BWP may hop to other frequency locations and span frequency ranges Δf₃ and Δf₄, respectively. As mentioned above, in accordance with embodiments, the frequency hopping of the sub-BWP may be employed for spreading the receptions and the transmissions over the RP so as to avoid or reduce potential collisions and interferences. The pattern in which the sub-BWP is hopping over frequency can be defined by configuring or preconfiguring a frequency offset between the current and next frequency range, for example, the offset between Δt1 and Δf₂.

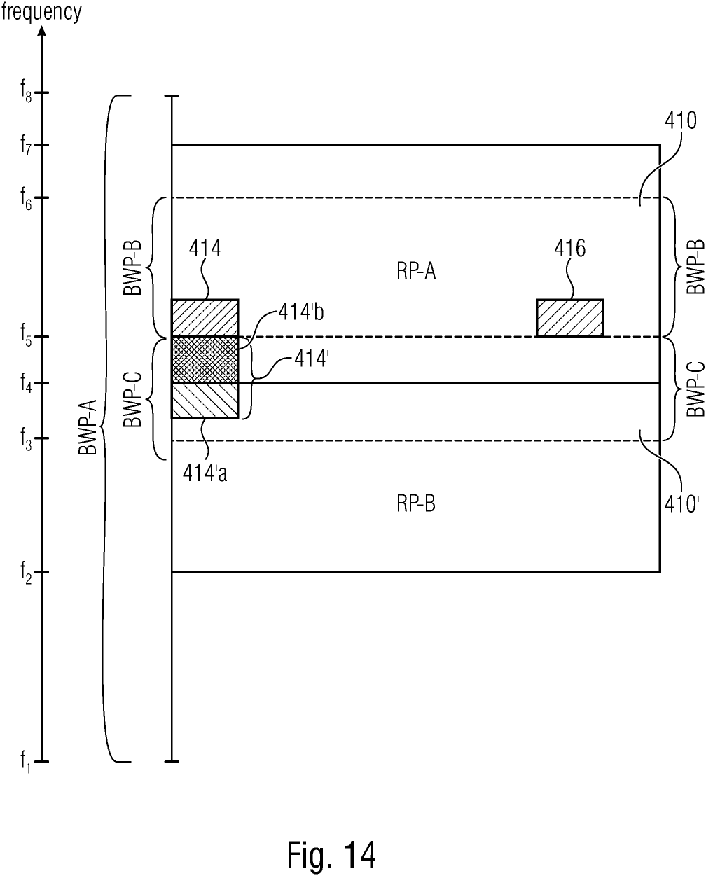

In accordance with further embodiments, more than one resource pool may be defined within a bandwidth part, and a sub-BWP monitored by a UE in accordance with the inventive approach may be associated with resources of two or more of the resource pools. FIG. 14 illustrates an embodiment in accordance with which two UEs in accordance with the present invention are assumed to operate on two different sub-BWPs, namely BWP-B and BWP-C. Similar as in the preceding figures, it is assumed than an overall bandwidth part BWP-A is defined for a certain communication, like a sidelink communication spanning the frequencies from f₁ to f₈. Within the BWP-A, two resource pools RP-A and RP-B spanning frequencies f₄ to f₇ and f₂ to f₄, respectively, are defined, and two UEs are assumed to operate, in accordance with the present invention, on subsets of frequency resources within the respective resource pools RP-A and RP-B, namely on sub-BWP-B and sub-BWP-C extending from frequency f₅ to f₆ and from frequency f₃ to f₅, respectively. In a similar way as described above with reference to FIG. 10 to FIG. 12, each of BWP-B and BWP-C has common resources 414, 414′ and 416 which, other than in the preceding embodiments, do not extend over all frequencies of BWP-B or BWP-C but only partially across the frequency in these bandwidth parts. In the embodiment of FIG. 14, BWP-C overlaps both resource pools RP-A and RP-B, and the UE operating on BWP-C monitors two sets of common resources 414′a and 414′b in the two resource pools RP-A and RP-B, while another UE operating in BWP-B only monitors the frequencies within RP-A and the common resources 414 and 416 in RP-A.

In the following, embodiments of the present invention are described in accordance with which an offset of the set of frequency resources on which the UE 400 operates are signaled or indicated. For example in case of sidelink communications, resource pools may be defined within one or more SL BWPs. In order to cater to lower power UEs or reduced capabilities UEs, such UEs may be configured, as described above, with a sub-BWP that is smaller than the SL BWP. In the BWPs, respective resource pools may be defined that fully or partially overlapping. However, transmissions by a UE 400 that operates using the sub-BWP may be directed to one or more other UEs that operate outside the smaller or sub-BWP, for example in the entire SL BWP or in a SL resource pool defined in the SL BWP. Also a transmission by one of the other UEs may be directed to the UE 400 operating only in the sub-BWP. Since the resource locations indicated in a control information, like a SCI, for a transmission are intricately linked to the resource pool configuration, the other UEs receiving a transmission from UE 400 operating only on the sub-BWP may not be able to determine the actual resources where transmissions are to be expected, because the SCI used by the UE 400 defines the resource locations with reference to the smaller or sub-BWP, whereas the receiving UE attempts to determine the resource location with respect to the SL RP in the large BWP. This may cause a mismatch when determining a resource location by the receiving UE.

Embodiments of the present invention address this issue, and in accordance with embodiments, the SCI may include an indication of a frequency offset, or a smaller resource pool may be configured with reference to a larger resource pool using a frequency offset.

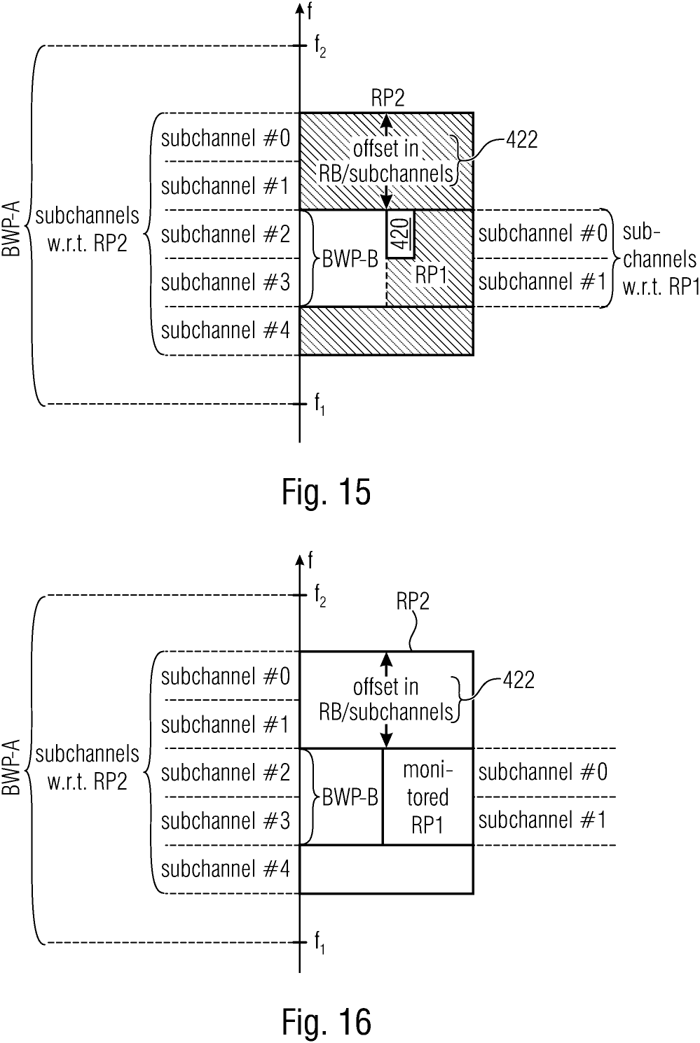

FIG. 15 illustrates an embodiment for an offset indication in a SCI in accordance with embodiments of the present invention. FIG. 15 illustrates a scenario, in which a system defines a bandwidth part BWP-A spanning frequencies f₁ to f₂, like a SL BWP. Within BWP-A, two resource pools RP1 and RP2 are defined, of which RP1 is fully within RP2. As is illustrated, RP1 has two subchannels and RP2 has five subchannels. In accordance with the present invention, a UE 400 or UE1 only operates on a sub-set of the frequency resources of the BWP-A, namely on the frequency resources defining BWP-B, and RP1 is defined in BWP-B. RP2 is defined in BWP-A and may be used by other UEs, like a UE2, not limited to an operation in BWP-B. When a SCI is transmitted by UE2 for a transmission directed to UE1, the SCI defines the resource locations with reference to RP2, which in frequency is subchannel#2 as indicated at 420. When UE1 receives this SCI, it will attempt to determine the resource locations with reference to RP1, causing a mismatch in the actual resource locations where the transmission occurs, since there is no subchannel#2 defined for RP1. UE1 is not able to use the configuration of RP2 since it is not aware of the configuration of RP2, which is defined with reference to BWP-A.

To address this issue and to avoid situations in which a UE does not receive data, in accordance with embodiments of the present invention, the SCI provided by the transmitting UE2 indicates that the resource locations are shifted, for example by indicating a frequency offset with reference to the resource pool for which the transmitting UE1 is configured. The frequency offset parameter is included in the SCI in order to inform UE1 that the resource locations indicated in the SCI are to be determined using the offset parameter. UE2 is able to determine the frequency offset accurately since it is configured with both RP1 and RP2. In the embodiment of FIG. 15, the frequency offset will be -2, which would enable UE1 to determine that the resource location is in subchannel#0 with reference to RP1, although the actual frequency location of the resource, as indicated in the SCI, was pointing to subchannel#2 with reference to RP2. This is possible because UE2 receives the configurations of both RP1 and RP2 since both the resource pools are within BWP-A. However, UE1 is aware of only RP1 since it is the only resource pool defined within BWP-B. With the offset parameter, UE2 informs UE1 that the resource locations defined in the SCI are with reference to RP2, and that using the offset parameter, UE1 may determine the exact resource locations with reference to RP1.

In accordance with further embodiments, in addition to the frequency offset parameter, also a resource pool ID parameter may be included in the SCI for informing the UE2 which resource pool configuration it needs to use and add the frequency offset value when determining the resource locations. This case is particularly relevant when multiple sub-BWPs, and RPs within these sub-BWPs, are defined within the larger BWP. In accordance with embodiments, the frequency offset may be indicated as a number of subchannels or as a number of resource blocks. For example, when UE1 transmits with reference to RP1, it does not include the offset since it is not aware of the configuration of RP2, which is defined with reference to BWP-A. Instead, when UE2 receives the SCI associated to the said transmission, based on the RP ID parameter, the UE uses the configuration of RP1 and not RP2 to determine the resource locations. The addition of the RP ID may also enable UE2 to transmit the SCI with the resource locations defined with reference to RP1, with the RP ID parameter indicating to UE1 which RP configuration to use when determining the resource locations.

In accordance with embodiments, a new first or a second stage SCI may be used to carry the additional parameters, the frequency offset and the resource pool ID, for enabling any receiving UE that receives the SCI to determine that the resource locations have to be calculated using the frequency offset with reference to the corresponding resource pool identified by the resource pool ID.

In accordance with further embodiments, the offset may be indicated by configuring the smaller resource pool with reference to the larger resource pool. FIG. 16 illustrates an embodiment for an offset indication of a RP defined in a sub-BWP with reference to another RP starting outside the sub-BWP. FIG. 16 illustrates a similar situation as in FIG. 15, namely that a large BWP-A is defined by the network to be used for a certain communication, like a sidelink communication. In FIG. 16 BWP-A spans frequencies f₁ to f₂. Within the BWP-A, a resource pool RP2 is defined and within the resource pool RP2 the subset of frequency resources or sub-BWP on which a UE in accordance with the present invention operates is defined, which is referred to in FIG. 16 as BWP-B. Within this BWP-B, the resource pool RP1 is defined, also referred to as the monitored RP, namely the RP monitored by UE1 operating in accordance with the present invention. However, other than in the embodiment of FIG. 15, the frequency resources are not defined with reference to the respective resource pools, rather they are described for RP1 with reference to RP2. When configuring RP1 on BWP-B, RP1 does not necessarily start at subchannel#0 of RP2. In FIG. 16 it is indicated that RP1 has subchannel#2 and subchannel#3, i.e., RP1 starts at subchannel#2 of RP2. RP2, in turn, includes, like in FIG. 15, the five subchannels and starts at subchannel#0 and extends to subchannel#4 within the BWP-A. As is indicated in FIG. 16, to indicate the offset and to have a common understanding of the subchannels within the configured RPs, the subchannels inside the BWP-B are indicated by an offset with reference to the first subchannel, namely subchannel#0 of RP2, as is indicated at 422.

In accordance with other embodiments, rather than signaling the offset 422 in the configuration, the actual start subchannel inside RP1 may be included so that rather than indicating subchannel#0 and subchannel#1 as in FIG. 15 for RP1, in the embodiment of FIG. 16, the actual subchannels of RP2 forming or defining RP1 are indicated in the configuration, namely subchannel#2 and subchannel#3.

This allows the RP1 to be within BWP-B and, at the same time, keep the resource indices of the larger RP, namely RP2, within which it is defined.

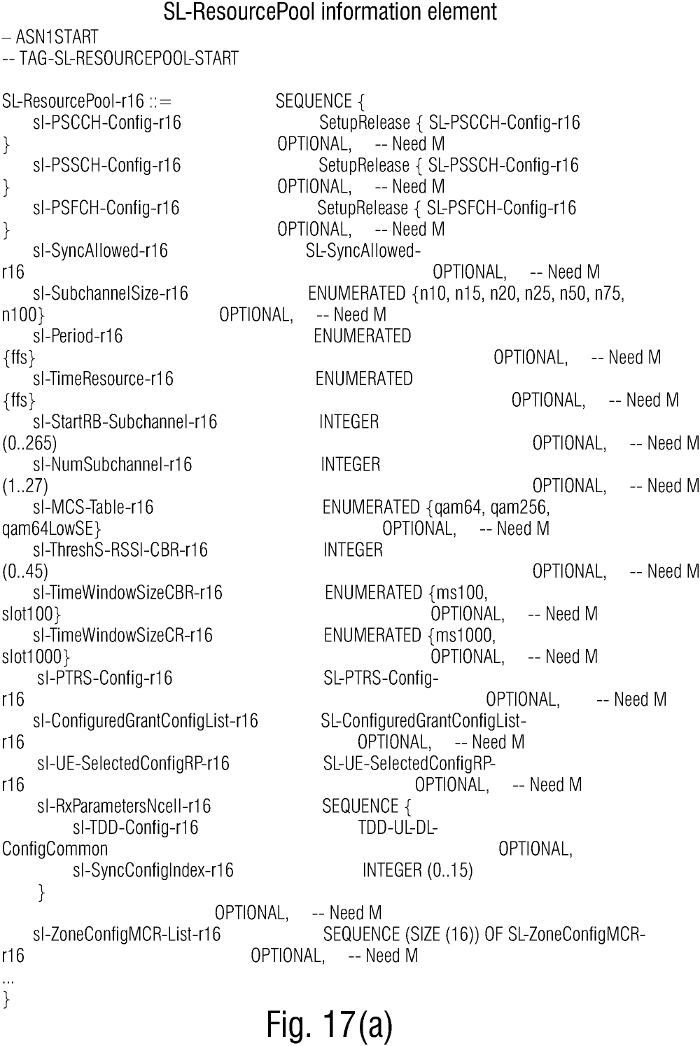

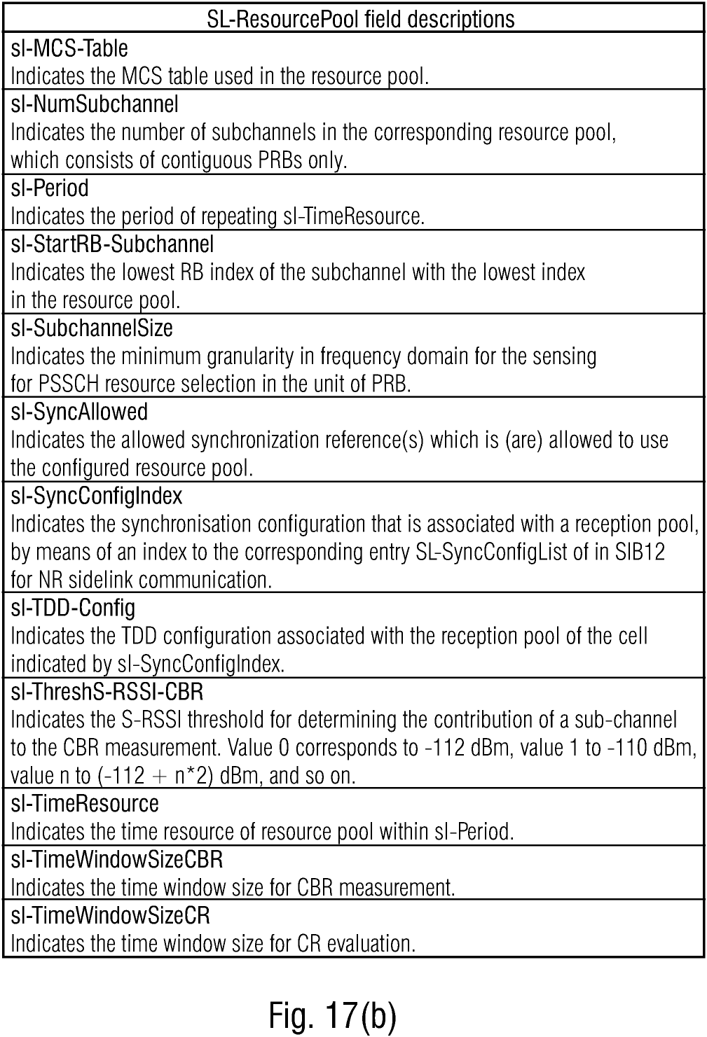

FIG. 17 illustrates an embodiment for signaling a sidelink resource pool configuration, which indicates, in accordance with the embodiment of FIG. 16, an offset of a RP defined in a sub-BWP with reference to another RP starting outside the sub-BWP. A SL-resource pool information element may be used, which is illustrated in FIG. 17(a) and includes the fields explained in the table in FIG. 17(b). By means of the information element in FIG. 17(a), the configuration may indicate the offset or the actual start channel of the RP1. The SL-resource pool information element may include the following additional fields for indicating the above-mentioned offsets:
sl-startSubchannelOffset (integer): this field indicates the first subchannel that is within the BPW-B,
sl-startResourcePoolOffset (integer): this field indicates the offset between subchannel 0 or resource block 0 of the RP2 or the BWP-A and the subchannel or start subchannel or RB0 of RP1.

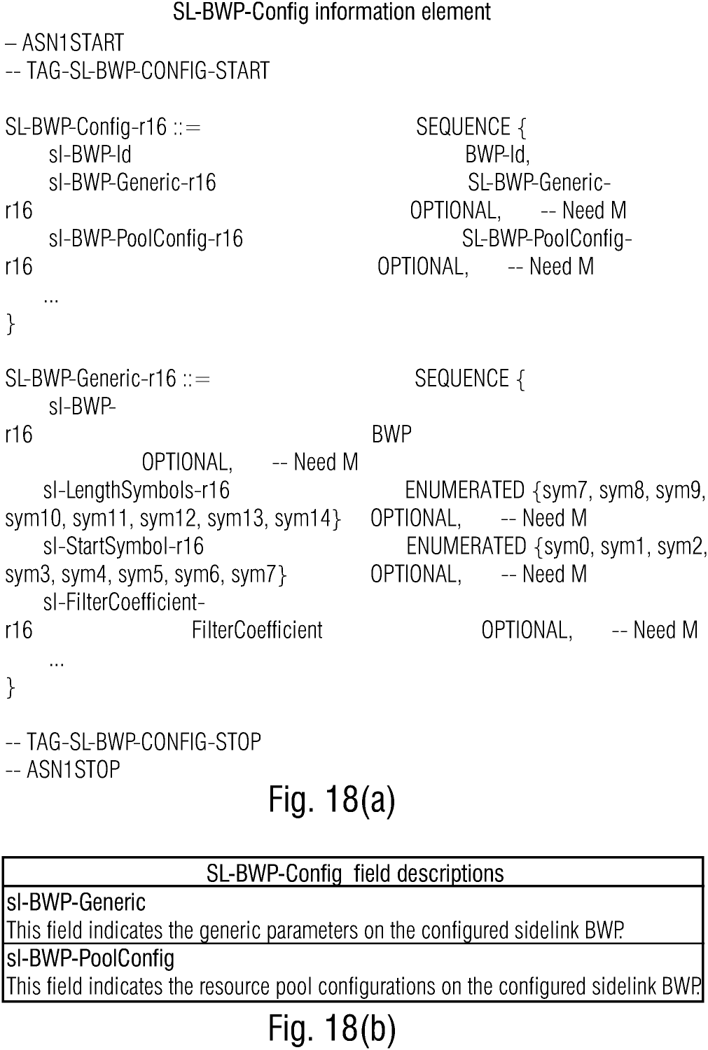

In accordance with embodiments of the inventive approach, the sub-BWP, like BWP-B in the above-described embodiments, may be signaled to a UE, like UE 400 of FIG. 8, using an information element as illustrated in FIG. 18(a) including the fields indicated in the table in FIG. 18(b). By means of the SL BWP-Config information element, the overall bandwidth part for the sidelink communication is defined together with respective resource pool configurations, like RP1 and RP2 described above as well as the BWP configuration for RP1. For example, the SL BWP defines an overall frequency within which communication takes place and/or resource pools are located. For example, it may be defined by a start frequency, a bandwidth and a numerology, i.e. subcarrier spacing, number of subcarriers. The sub-BWP is located within the BWP and may further comprise a relative position with regard to the BWP.

In accordance with further embodiments, additional information elements may be provided for indicating one or more frequency patterns for frequency hopping of BWP-B, for example similar to fields used for PUSCH frequency hopping. Another IE, information element, may be provided for indicating a BWP sequence and duration. For example, the BWP sequence is a time sequence of multiple BWPs that are switched after a certain duration each, where the duration may be the same for all BWPs of the BWP sequence or given as a time pattern.

In accordance with further embodiments, the inventive approach may be applied in combination with a reduced sensing that is carried out within a short sensing window SSW or short listening window SLW, an approach that is described in more detail in European application 20183530.3 filed on Jul. 1, 2020 and having the title “Resource Reservation Prediction for Sidelink UEs”, which is incorporated herein by reference. For example, when considering a sidelink resource pool, like the RPs described above, a short sensing or listening window may be defined during which the UE carries out sensing. In other words, the UE carries out sensing on time resources that lie within the predefined sensing window, however, no other operations are carried out outside the sensing window, so as to allow the UE to conserve power. However, the UE is still expected to carry out sensing across all frequencies or subchannels defined in the resource pool, i.e., in each time slot within the SSW, all subchannels are sensed. To allow for the UE to achieve a further power efficiency, in accordance with further embodiments, the above-described inventive approach of using only a subset of frequency resources is combined with the approach of providing a short sensing window so that when the UE carries out sensing within the SSW, this is performed only on a subset of the frequency resources, and not across all the frequency resources defined in a resource pool or bandwidth part, i.e., only some of the subchannels are sensed. From the FRIV value indicated in the SCI, the UE is aware of future subchannel locations for a transmission so that the UE may avoid scanning all the subchannels of a resource pool, and may limit the sensing to those resources where the future resources are actually indicated, i.e., to the time/frequency resources carrying the SCI and the additional time/frequency resources indicated by the TRIV and FRIV values included in the SCI. In accordance with embodiments, the sensing only on the subset of the frequency resources of the resource pool may be done only during the time slots when sensing is performed, namely during the SSW.

In accordance with further embodiments, the reduced sensing across frequency may not be restricted to only the time slots in the SSW, however, in accordance with other embodiments, the UE may carry out reduced sensing across frequency in time slots outside the SSW, e.g., in some or every time slot defined in the resource pool.

In accordance with embodiments, the above-described reduced sensing across frequency may be defined as a sensing frequency region, SFR, that includes a subset of the subchannels or RBs defined for a resource pool or set of resources.

In accordance with embodiments, the SFR may be defined by a network entity, like a gNB, as a resource pool characteristic. In such a scenario, the resource pool configuration or definition indicates to the UE those subchannels the UE is to carry out sensing on. In accordance with other embodiments, the UE may decide the SFR on its own. In this case, in accordance with embodiments, the UE may carry out sensing for a certain period of time for detecting a pattern on the subchannels where future resources are scheduled to be used for a transmission by other UEs. Based on this information, the UE may separate the subchannels where transmissions from other UEs are expected into shorter sensing frequency regions, SFRs.

In accordance with embodiments, the SFR may be defined to include a plurality of frequency resources which are contiguous or are separated by respective non-sensing-intervals.

In accordance with embodiments, the SFR is defined using one or more of the following parameters:
a starting RB or subchannel index,
a contiguous set of RBs or subchannels,
a pattern across frequency,
a pattern across frequency and time.

In accordance with embodiments, the SFR is defined as a pattern across frequency using one or more of the following parameters:
the resources across a frequency of the set of resources, like RBs or subchannels in which the UE is to carry out sensing,
the resources across a frequency of the set of resources in which the UE is not carrying out sensing,
the frequency gap or offset between two consecutive subsets of frequency resources where the UE is to carry out sensing,
a periodicity of the frequency pattern,
an overall frequency band for which the frequency pattern repeats.

In accordance with embodiments, the UE may carry out the sensing within the SSWs, and in such a case, a decision time period may be employed during which the UE carries out sensing across all subchannels within the SSWs so as to determine subchannels where future resources are scheduled for use by other UEs. The decision time period may be defined based on an absolute number of time slots within which the UE carries out sensing of all the subchannels, and the period may be with or without the SSW defined. In case the SSW is used, the UE may calculate the period only in the time slots when it carries out sensing, i.e., the time slots of the SSW. In accordance with other embodiments, the decision time period may also be defined as a number of SSWs within which the UE carries out sensing in all subchannels.

Once the decision time period elapses, the UE generates a map for all subchannels where the most resources are reserved, and based on this map the UE may decide to define the SFR, namely the sets of subchannels where the UE carries out sensing. In other words, based on the information of subchannels that are used for transmissions by other UEs, the UE may preclude such channels from future sensing operations. The decision time period, in accordance with embodiments, may be repeated periodically, so that the UE carries out sensing across all subchannels periodically, and after determining the SFR, the UE may switch to sensing only in the subchannels indicated in SFR.

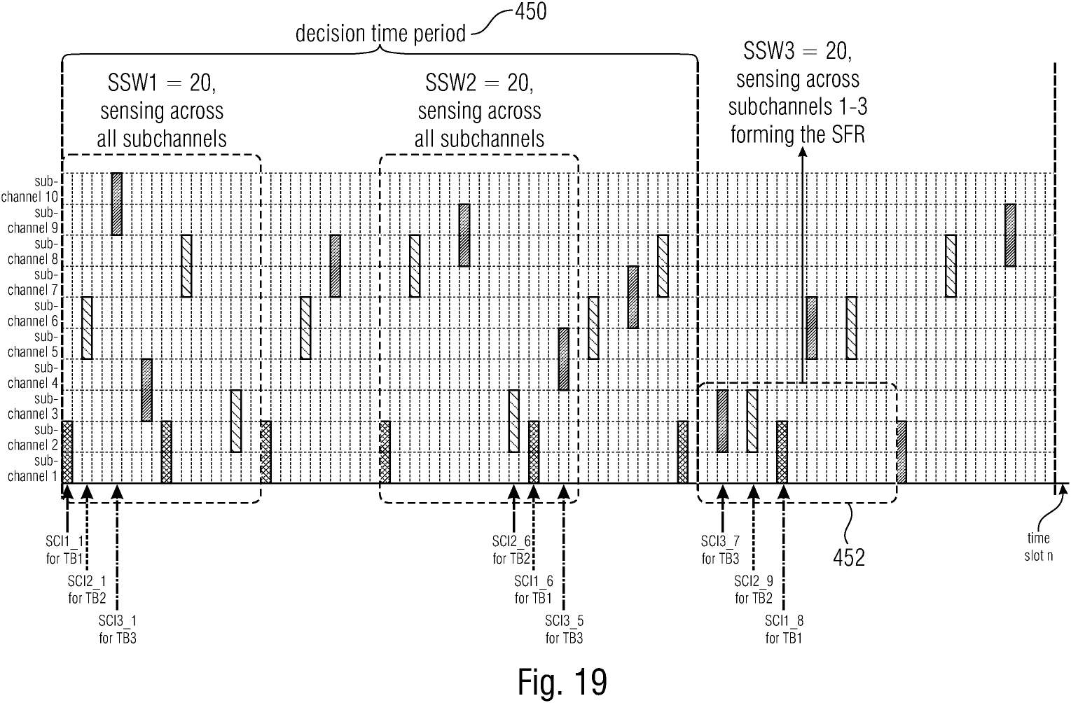

FIG. 19 illustrates an embodiment for determining the SFR within a SSW using a decision time period. FIG. 19 illustrates a part of a sidelink resource pool that may include more time slots and more subchannels across frequency than those shown in the figure. The sidelink resource pool may be sensed by the UE 400 for a transmission after the time slot n. In FIG. 19, several SCIs are sensed for several transmissions or transport blocks TB1 to TB3. As may be seen from FIG. 19, the SCIs for the respective transport blocks are received at different time slots and in different subchannels, and the transmission of the SCI, in the depicted embodiment, uses one time slot and two subchannels. Dependent on the TRIV value included in the SCI, the additional transmissions for the respective transport blocks are indicated. When considering the multiple transmissions of transport blocks TB1, TB2 and TB3 in the resource pool comprising ten subchannels, a decision time period 450 is defined during which the UE carries out sensing across all subchannels, and once the decision time period 450 has elapsed, the UE defines the SFR for only subchannels 1 to 3 as indicated at 452.

This is based on the TRIV and FRIV information the UE receives during the sensing windows SSW1 and SSW2 that are within the decision time period 450. Based on the TRIV and FRIV received in SCI 1_6 for TB1, the UE is aware that subchannels 1 and 2 need to be monitored. Based on SCI 3_5 for TB3, the UE monitors subchannels 2 and 3. Using this information, the UE defines the SFR to be subchannels 1 to 3. When the UE reads SCI 2_6 for TB2 it determines that the remaining two future reservations occur before the next SSW so that no information for the next transmission of TB2 in upcoming SSW is given. Therefore, the UE does not take the SCI 2_6 into consideration when deciding the SFR.

Within the SSW3 and within the SFR, the UE senses SCI 1_8, SCI 2_9 and SCI 3_7 for transport blocks TB1, TB2 and TB3, respectively. Although in the next transmissions of TB2 and TB3 are not within the SFR 452, the UE is able to determine the time and frequency resources that they occupy based on the received SCI 2_9 and SCI 3_7. At the same time, the UE is able to save power by sensing only three out of ten subchannels defined in the resource pool but still obtains the same results as if it sensed all the subchannels.

In accordance with further embodiments, a subchannel detection rate, SCDR, may be defined to quantify a gain or loss due to missed transmissions from the other UEs when UE 400 is not sensing, for example when it is in a sleep or power down phase so that no sensing across all subchannels is carried out. The subchannel detection rate may be defined as the rate of subchannels where the UE carries out sensing to a total number of subchannels defined for a resource pool or a set of resources.

Altering or changing the SCDR directly impacts the size or the SFR. For example, a high SCDR means that the UE carries out sensing in most of the subchannels so that the SFR may cover most of the subchannels defined in the resource pool. On the other hand, a low SCDR means that the SFR covers only a few of the subchannels defined in the resource pool resulting in high power savings but at the expense of a deterioration of the sensing results.

In accordance with embodiments, the UE may decide to alter the SCDR and the associated impacts on the SFR, dependent on one or more criteria, for example the priority of a transmission and/or a congestion status. For example, when considering the priority of the transmission for which the UE is carrying out sensing, in case of a high priority transmission, the UE may choose to maintain a high SCDR so as to carry out sensing in most of the subchannels and to become aware of resources used for transmissions by other UEs. On the other hand, in case of low priority transmissions, the UE may choose to lower the SCDR. When considering the congestion status of the overall resource pool, in case a highly congested resource pool, like a congestion being above a certain threshold, is determined, the UE does not repeatedly turn on and off the sensing due to the risk of missing out on sensing other transmissions from other UEs. In that case, the UE may set a high SCDR close to 1 in order to sense almost all the subchannels, at the expense of saving power.

Other criteria causing the UE to alter the SCDR may include one or more of the following criteria:
a power status of the UE,
a service type, e.g. PPDR services or pedestrian services, for which the UE is configured or preconfigured to use or cater to,
a change in QoS, priority, or traffic type for a transmission to be made by the UE,
in case of a change in motion state of the UE,
in case the UE changes a geographic area,
the UE moving from in coverage to out-of-coverage a base station or from out-of-coverage to in coverage of a base station, for example, when changing from one resource pool configuration to another.

In accordance with embodiments, the UE, like a mode 2 UE, may be configured or preconfigured to use a mapping of the SCDR based on a channel busy ratio, CBR, or a congestion ratio, CR, of the resource pool. This allows the UE to use the resource pool to determine the SCDR based on the congestion status of the resource pool and accordingly select the SFR. For example, a look-up table may be provided to map the SCDR to a certain congestion status of the resource pool. The table may be defined in the specification and the UEs operating in accordance with the specification may be aware of this table. Based on the table, the UE may determine the priority of transmission it is able to transmit. For example, with an SCDR of 20%, the UE may determine that it only is able to transmit a low priority transmission.

In accordance with yet other embodiments of the present invention, a so-called minimal sensing set may be provided. The minimal sensing set may be a basic or minimal set of subchannels that every UE is expected to sense and monitor. The features of such a minimal set of subchannels may be as follows:
when the UE is awake, like in DRX mode, the UE monitors at least the minimal set of subchannels,
more than one minimal subchannel may be defined,
the minimal sensing set may depend on a service type, like public safety UEs or wearables, or a cast type, like unicast, groupcast or broadcast, or a priority associated with the transmission.

The same set of minimal subchannels that a receiving UE is expected to monitor needs to be known to the transmitting UE as well, so that the UE makes sure that its transmissions are received by the receiving UE in case the receiving UE is a recipient of the transmission.

The UE may sense and monitor at least the minimal set of frequency resources at certain time intervals resulting in a minimal set of time/frequency resources that are monitored, and the time intervals may be derived from:
a DRX configuration, or
a search space, or
a DRX_ON duration.

### General

Although the respective aspects and embodiments of the inventive approach have been described separately, it is noted that each of the aspects/embodiments may be implemented independent from the other, or some or all of the aspects/embodiments may be combined. Moreover, the subsequently described embodiments may be used for each of the aspects/embodiments described so far.

Although some of the embodiments above are described with reference to a Mode 2 UE, it is noted that the present invention is not limited to such embodiments. The teachings of the present invention as descried herein are equally applicable to Mode 1 UEs carrying out sensing to obtain, e.g., a sensing report for providing an occupancy status of one or more resources or resource sets.

Although some of the embodiments above are described with reference to a sidelink pool, it is noted that the present invention is not limited to such embodiments. Rather, the inventive approach may be implemented in a system or network providing a set or resources to be used for a certain communication between UEs in the network, and the above described subset of time resources or SSW according to the present invention has a number of time resources that is less than the total number of resources within the set of resources. The time resource may be a number of time slots, subframe, radio frames, radio resources in time, a number of PRBs in time domain, also spanning a frequency, subchannel, BWP, etc.

The set of resources may be preconfigured so that the entities of the network are aware of the set of resources provided by the network, or the entities may be configured by the network with the set of resources.

Thus, the set of resources provided by the network may be defined as one or more of the following:
a sidelink resource pool, to be used by the UE for sidelink communications, e.g. direct UE-to-UE communication via PC5,
a configured grant including or consisting of resources to be used by the UE for NR - U communications,
a configured grant including or consisting of resources to be used a reduced capability UE.

In accordance with embodiments, the set or resources may include one or more sensing regions, e.g., regions per resource pool or per TX/RX resource pool for Mode 1 and/or Mode 2 UEs. A UE may be configured or preconfigured with the one or more sensing regions by the wireless communication network, and the one or more subsets are defined within the one or more sensing regions. For example, a sensing region may span a certain time interval.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, a mobile terminal, or a stationary terminal, or a cellular IoT-UE, or a vehicular UE, or a vehicular group leader (GL) UE, or a sidelink relay, or an IoT or narrowband loT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

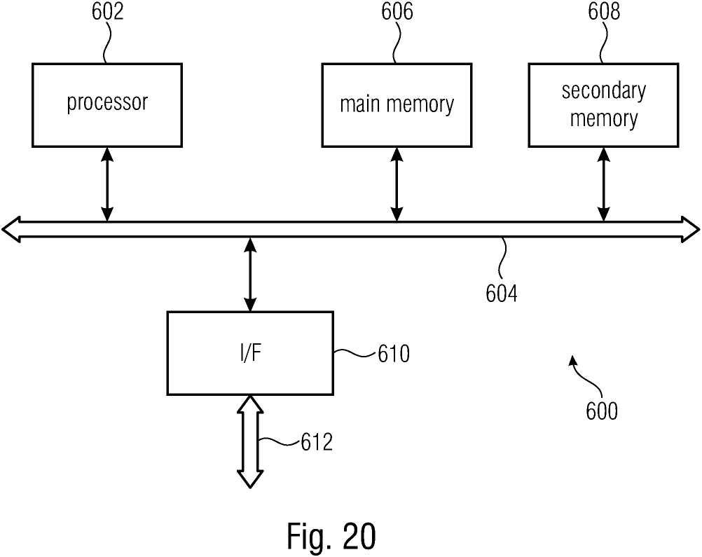

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 20 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A user device, UE, for a wireless communication network,
wherein a set of resources is provided for a communication in the wireless communication network, and
wherein the UE is to operate, e.g., carry out sensing, only on one or more subsets of frequency resources of the set of resources, wherein a number of frequency resources of the subset of frequency resources is less than a total number of frequency resources of the set of resources.

2. The user device, UE, of claim 1, wherein outside the one or more subsets of frequency resources the UE is not to operate, e.g., not to carry out one or more of the following:
sensing,
data transmission and/or reception.

3. The user device, UE, of claim 1, wherein a further set of resources is provided in the wireless communication network for a communication, and wherein the UE is to operate on some or all of the further set of resources.

4. The user device, UE, of claim 1, wherein the UE is to operate on a plurality of subsets of frequency resources, the plurality of subsets of frequency resources being contiguous or being separated, e.g., by respective non-sensing-intervals.

5. The user device, UE, of claim 1, wherein
the set of resources comprises a plurality of time and frequency resources, and
the UE is to carry out sensing only on one or more subsets of time resources of the set of resources, wherein a number of time resources of the one or more subsets is less than the total number of time resources within the set of resources provided by the network.

6-24. (canceled)

25. The user device, UE, of claim 5, wherein outside the one or more subsets of time resources the UE is not to carry out one or more of the following:
sensing,
data transmission and/or reception,
switching between reception and transmission,
switching between transmission and reception.

26. The user device, UE, of claim 5, wherein the UE is to carry out sensing on a plurality of subsets of time resources, the plurality of subsets of time resources being separated by respective non-sensing-intervals.

27. The user device, UE, of claim 5, wherein the UE is to carry out sensing only on certain frequency resources of the subset of frequency resources.

28. The user device, UE, of claim 27, wherein the UE is to carry out sensing in one or more sensing frequency regions, SFRs, the SFR comprising only the certain frequency resources of the subset of frequency resources.

29. The user device, UE, of claim 28, wherein
the UE is to receive from the wireless communication network the SFR, or
the UE is to receive the SFR from another UE via sidelink, or
the UE is to determine the SFR, and
to determine the SFR, the UE is to
carry out sensing across all frequency resources for detecting a pattern of frequency resources to be used for transmissions by other UEs, and/or
using the sensing results, define the SFR.

30. (canceled)

31. The user device, UE, of claim 28, wherein the SFR is defined to comprise a plurality of frequency resources, the plurality of frequency resources being contiguous or being separated by respective non-sensing-intervals.

32. The user device, UE, of claim 28, wherein the SFR is defined using one or more of the following parameters:
a starting RB or subchannel index,
a contiguous set of RBs or subchannels,
a pattern across frequency,
a pattern across frequency and time.

33. The user device, UE, of claim 32, wherein the SFR is defined as a pattern across frequency using one or more of the following parameters:
the resources across a frequency of the set of resources in which the UE is to carry out sensing,
the resources across a frequency of the set of resources in which the UE is not carrying out sensing,
the frequency gap or offset between two consecutive subsets of frequency resources where the UE is to carry out sensing,
a periodicity of the frequency pattern,
an overall frequency band for which the frequency pattern repeats.

34. The user device, UE, of claim 29, wherein the UE is to carry out sensing across all frequency resources for a decision time period, the decision time period being
based on an absolute number of time slots within which the UE is to carry out sensing of all frequency resources, or
defined as a number of subsets of time resources of the set of resources within which the UE carries out sensing of all frequency resources.

35. The user device, UE, of claim 34, wherein the decision time period is repeated periodically.

36. The user device, UE, of claim 28, wherein the SFR depends on a subchannel detection rate, SCDR, the SCDR being defined as a number of frequency resources or subchannels where the UE is to carry out sensing to a total number of frequency resources or subchannels in the subset of frequency resources.

37. The user device, UE, of claim 36, wherein the UE is to alter the SCDR depending on one or more criteria, which may comprise one or more of the following:
a priority of a transmission for which the UE is carrying out sensing,
a congestion status of the set of resources,
a power status of the UE,
a service type, e.g. PPDR services or pedestrian services, for which the UE is configured or preconfigured to use or cater to,
a change in QoS, priority, or traffic type for a transmission to be made by the UE,
in case of a change in motion state of the UE,
in case the UE changes a geographic area,
the UE moving from in coverage to out-of-coverage a base station or from out-of-coverage to in coverage of a base station, e.g., when changing from one resource pool configuration to another,
responsive to receiving or sending a trigger via a sidelink.

38. The user device, UE, of claim 36, wherein
the UE is configured or pre-configured with a lookup table, the lookup table mapping the SCDR to a congestion status of the set of resources,
using the congestion status and the lookup table, the UE is to determine a priority of transmissions that the UE is capable to transmit.

39-43. (canceled)

44. A wireless communication network, comprising one or more user devices, UEs, of claim 1.

45-46. (canceled)

47. A method of operating a user device, UE, in a wireless communication network, the method comprising:
providing a set of resources for a communication in the wireless communication network, and
operating the UE, e.g., carrying out sensing, only on one or more subsets of frequency resources of the set of resources, wherein a number of frequency resources of the subset of frequency resources is less than a total number of frequency resources of the set of resources.

48. (canceled)
